(19) United States
(12) Patent Application Publication
(10) Pub. No.: US 2022/0396710 A1
(43) Pub. Date: Dec. 15, 2022

(54) FIXER COMPOSITION

(71) Applicant: Hewlett-Packard Development Company, L.P., Spring, TX (US)

(72) Inventors: Dennis Z. Guo, San Diego, CA (US); Jie Zheng, San Diego, CA (US)

(21) Appl. No.: 17/762,262

(22) PCT Filed: Jan. 20, 2020
(86) PCT No.: PCT/US2020/014270

§ 371 Date: Mar. 21, 2022

(51) Int. Cl. C09D 11/54; C09D 11/322; C09D 11/38; D06P 5/30

(52) U.S. Cl. CPC C09D 11/54; C09D 11/322; C09D 11/38; D06P 5/30

(57) ABSTRACT

An example fixer composition includes a glycidyl amine resin, an acid, a co-solvent, and a balance of water. The glycidyl amine resin includes at least two epoxide groups, a phenyl group, and a tertiary amine group. The fixer composition may be included in a printing kit with an ink composition. In an example, the ink composition including a pigment, a polymeric binder, and an aqueous ink vehicle.

### BACKGROUND

Textile printing methods often include rotary and/or flat-screen printing. Traditional analog printing typically involves the creation of a plate or a screen, i.e., an actual physical image from which ink is transferred to the textile. Both rotary and flat screen printing have great volume throughput capacity, but also have limitations on the maximum image size that can be printed. For large images, pattern repeats are used. Conversely, digital inkjet printing enables greater flexibility in the printing process, where images of any desirable size can be printed immediately from an electronic image without pattern repeats. Inkjet printers are gaining acceptance for digital textile printing, e.g., for creating signs, banners, artwork, apparel, wall coverings, window coverings, upholstery, pillows, blankets, flags, tote bags, clothing, etc. Inkjet printing is a non-impact printing method that utilizes electronic signals to control and direct droplets or a stream of ink to be deposited on media.

### BRIEF DESCRIPTION OF THE DRAWINGS

Features of examples of the present disclosure will become apparent by reference to the following detailed description and drawings, in which like reference numerals correspond to similar, though perhaps not identical, components. For the sake of brevity, reference numerals or features having a previously described function may or may not be described in connection with other drawings in which they appear.

FIG. 1 schematically illustrates an example fluid set and an example textile printing kit, each of which includes an example of a fixer composition and an example of an ink composition;

FIG. 2 is a flow diagram illustrating an example printing method; and

FIG. 3 is a schematic diagram of an example of a printing system.

### DETAILED DESCRIPTION

The textile market is a major industry, and printing on textiles, such as cotton, polyester, etc., has been evolving to include digital printing methods. However, the vast majority of textile printing (95%), or at least some portion of the textile printing process, is still performed by analog methods, such as screen printing. For example, fixer or pre-treatment compositions, which may be used to improve ink adhesion, are often printed on textiles by analog methods, such as spraying, coating, etc. Many fixer or pre-treatment compositions include resins, cationic fixing agents, and other components that can render the composition unsuitable for use in thermal inkjet printing methods. Moreover, analog methods coat the entire textile. In many instances, the subsequently deposited ink, which generates an image, text, etc., does not cover the entire textile, and thus the fixer or pre-treatment composition is wasted.

Disclosed herein is a fixer composition that is particularly suitable for digital thermal inkjet printing. The fixer composition is a pre-treatment fluid that is used to treat the textile fabric before any ink is printed thereon. As such, the fixer composition is printed prior to any ink.

The fixer composition disclosed herein includes a glycidyl amine resin and an acid, which together improve the jettability of the fixer composition and generate prints having desirable optical density and durability (e.g., washfastness). The acid helps to dissolve the glycidyl amine resin in the aqueous fixer vehicle (e.g., water and co-solvent), which improves the jettability. The acid also renders a tertiary amine group of the glycidyl amine resin cationic (positively charged). While not being limited to any theory, the positive charge can improve the adhesion of the fixer composition to any textile fabric with reactive groups (e.g., —OH, —SH, —NH₂, etc.) present at the surface. The positive charge can also fix pigments in an ink composition that is applied to the treated textile fabric, which improves the optical density of the textile print.

The glycidyl amine resin that is used in the fixer composition disclosed herein includes at least two epoxide groups, a phenyl group, and tertiary amine group. This resin is stable because it is non-self-reactive, e.g., the epoxide groups are not reactive with the tertiary amine. This resin may also help to improve the durability of the textile print because it is reactive with the ink and/or the textile fabric. More specifically, the epoxide groups of the resin are capable of crosslinking with i) primary and/or secondary amino functional groups that may be present in the ink that is applied to the treated textile fabric and/or ii) reactive groups that may be present at the surface of the textile fabric.

The fixer composition is stable at a pH of about 8.5 or less. Additionally, the fixer composition is positively charged while the ink composition is negatively charged. By maintaining the fixer and ink compositions separately, the epoxide groups are prevented from prematurely crosslinking in solution with reactive groups that may be present in the ink composition. As such, in the examples disclosed herein, the fixer composition and the ink composition are maintained in separate containers or separate compartments in a single container until the compositions are printed.

Throughout this disclosure, a weight percentage that is referred to as “wt % active” refers to the loading of an active component of a dispersion or other formulation that is present in the fixer composition or the ink composition. For example, a pigment may be present in a water-based formulation (e.g., a stock solution or dispersion) before being incorporated into the ink composition. In this example, the wt % actives of the pigment accounts for the loading (as a weight percent) of the pigment that is present in the ink composition, and does not account for the weight of the other components (e.g., water, etc.) that are present in the formulation with the pigment. The term “wt %,” without the term actives, refers to either i) the loading (in the fixer or ink composition) of a 100% active component that does not include other non-active components therein, or ii) the loading (in the fixer or ink composition) of a material or component that is used “as is” and thus the wt % accounts for both active and non-active components.

The various compositions will now be described.

Fixer Composition

Examples of the fixer composition disclosed herein include a glycidyl amine resin including at least two epoxide groups, a phenyl group, and a tertiary amine group; an acid; a co-solvent; and a balance of water. In some examples, the fixer composition consists of the glycidyl amine resin including at least two epoxide groups, the phenyl group, and the tertiary amine group; the acid; the co-solvent; and the balance of water; and thus does not include any other components. In other examples, the fixer composition may further include a non-ionic surfactant, a cationic surfactant, and/or a zwitterionic surfactant.

The glycidyl amine resin including at least two epoxide groups, a phenyl group, and a tertiary amine group. Some specific examples of these glycidyl amine resins are selected from the group consisting of: tetraglycidyl meta-xylenediamine:

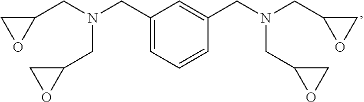 [SMILES: c1cc(CN(CC2CO2)CC2CO2)cc(CN(CC2CO2)CC2CO2)c1]

N,N′-tetraglycidyl diaminodiphenylmethane:

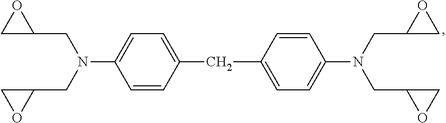 [SMILES: c1cc(N(CC2CO2)CC2CO2)ccc1Cc1ccc(N(CC2CO2)CC2CO2)cc1]

triglycidylether meta-aminophenol:

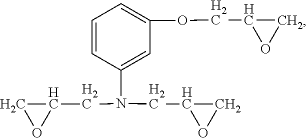 [SMILES: c1cc(OCC2CO2)cc(N(CC2CO2)CC2CO2)c1]

triglycidylether para-aminophenol:

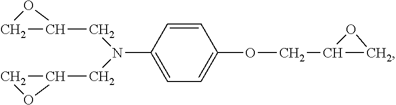 [SMILES: c1cc(N(CC2CO2)CC2CO2)ccc1OCC1CO1]

and combinations thereof. The glycidyl amine resins may be commercially available. For example, tetraglycidyl meta-xylenediamine is commercially available under the tradename ERISYS® GA-240 from CVC Thermoset Specialties. N,N′-tetraglycidyl diaminodiphenylmethane is commercially available under the tradename ARALDITE® MY 721 from Huntsman Corp. Triglycidylether meta-aminophenol is commercially available under the tradename ARALDITE® MY 0600 from Huntsman Corp. Triglycidylether para-aminophenol is commercially available under the tradename ARALDITE® MY 0500 from Huntsman Corp.

As mentioned, the epoxide groups provide the fixer composition with crosslinking functionality. When the fixer composition is printed, the epoxide groups can interact or react with suitable reactive groups that may be present at a surface of the polymeric binder in the ink composition (which is printed on the fixer composition), and/or in some instances, with hydroxyl groups (e.g., for cotton), amine groups (e.g., for nylon), thiol groups (e.g., for wool), or other suitable reactive groups that may be present at the surface of the textile fabric. The interaction between the groups in the fixer composition and the groups in the ink composition and/or the groups at the surface of the textile fabric generate a high quality image that exhibits durability, as demonstrated in the examples set forth herein.

Some example reactions between the epoxide group(s) and various reactive groups of the polymeric binder and/or of the textile fabric are illustrated below in Schemes I-III, as follows:

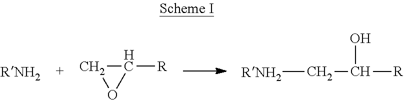

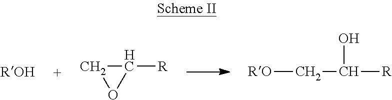

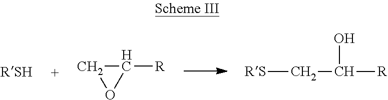

In Schemes I-III, the R represents portions of the resin that may not be directly part of the reaction shown in Schemes I-III, and are thus not shown, but include, for example, the phenyl group and the tertiary amine group. Likewise, R′ represents portions of the polymeric binder and/or of the textile fabric that may not be directly part of the reaction shown in Schemes I-III.

In further detail, in accordance with examples of the present disclosure, the epoxide groups present in the fixer composition can interact with the polymeric binder, the textile fabric, or both to form a covalent linkage therewith, as shown in Schemes I-III above. Other types of reactions can also occur, but Schemes I-III are provided to illustrate examples of reactions that can occur when the ink composition, the textile fabric, or both come into contact with the fixer composition.

Also as mentioned, the tertiary amine group provides the fixer composition with cationic functionality. The tertiary amine group becomes cationic in the presence of the acid in the fixer composition. The positively charged cation can help to fix negatively charged pigments in an ink composition that is applied to the treated textile fabric and/or improve the adhesion of the fixer composition to any textile fabric with reactive groups (e.g., —OH, —SH, etc.) present at the surface.

In an example, the glycidyl amine resin is present in an amount ranging from about 0.5 wt % active to about 12 wt % active based on a total weight of the fixer composition. In further examples, the glycidyl amine resin is present in an amount ranging from about 1 wt % active to about 10 wt % active; or from about 2 wt % active to about 8 wt % active; or from about 4 wt % active to about 6.5 wt % active, based on a total weight of the fixer composition.

The fixer composition also includes an acid. As mentioned, the acid helps dissolve the glycidyl amine resin in water and also renders the glycidyl amine resin cationic. Examples of suitable acids are selected from the group consisting of CH₃COOH (acetic acid), HCO₂H (formic acid), alkyl-CO₂H, HCl (hydrochloric acid), HNO₃ (nitric acid), H₂SO₄ (sulfuric acid), and alkyl-SO₃H. With alkyl-CO₂H and alkyl-SO₃H, the alkyl may be a C1 alkyl (—CH₃) to a C8 alkyl (—(CH₂)₇CH₃).

The amount of the acid included in the fixer composition will depend, at least in part, on the stoichiometry of the amine groups in the glycidyl amine resin. When the glycidyl amine resin includes two amine groups, it may be desirable for the molar ratio of the tertiary amine group(s) of the glycidyl amine resin to the acid to be 1:2. In other examples, a molar ratio of the tertiary amine group(s) of the glycidyl amine resin to the acid ranges from 1:0.5 to about 1:2.

The fixer composition also includes a co-solvent. The co-solvent is water miscible. For water-based epoxy resins, the co-solvent may be a glycol ether or a lactam. For waterborne epoxy resins, the co-solvent may be diacetone alcohol. In one example of the fixer composition, the co-solvent is selected from the group consisting of propylene glycol monomethyl ether, propylene glycol propyl ether, dipropylene glycol n-butyl ether, propylene glycol phenyl ether, tripropylene glycol n-butyl ether, ethylene glycol butyl ether, dipropylene glycol methyl ether, diacetone alcohol, 2-pyrrolidone, N-methyl-2-pyrrolidone, N-ethyl-2-pyrrolidone 2-piperidinone, and combinations thereof.

In an example, the co-solvent is present in an amount ranging from about 1 wt % to about 20 wt % based on a total weight of the fixer composition. Whether used alone or in a combination, the total co-solvent amount is within this range. In further examples, the co-solvent is present in an amount ranging from about 2 wt % to about 15 wt %; or from about 2.5 wt % to about 10 wt %; or from about 3 wt % to about 8 wt %, based on a total weight of the fixer composition.

The fixer composition may further include a surfactant. The surfactant may be any surfactant that aids in wetting, but that does not deleteriously interact with the resin and acid in the fixer composition. In an example, the fixer composition further includes a non-ionic surfactant, a cationic surfactant, a zwitterionic surfactant, or combinations thereof. The fixer composition does not include an anionic surfactant.

Examples of suitable non-ionic surfactants include non-ionic fluorosurfactants, non-ionic acetylenic diol surfactants, non-ionic ethoxylated alcohol surfactants, and combinations thereof. Several commercially available non-ionic surfactants that can be used in the formulation of the fixer composition include ethoxylated alcohols/secondary alcohol ethoxylates such as those from the TERGITOL® series (e.g., TERGITOL® 15-S-30, TERGITOL® 15-S-9, TERGITOL®15-S-7), manufactured by Dow Chemical; surfactants from the SURFYNOL® series (e.g., SURFYNOL® SE-F (i.e., a self-emulsifiable wetting agent based on acetylenic diol chemistry), SURFYNOL® 440 and SURFYNOL® 465 (i.e., ethoxylated 2,4,7,9-tetramethyl 5 decyn-4,7-diol)) manufactured by Evonik Industries, and the DYNOL™ series (e.g., DYNOL™ 607 and DYNOL™ 604) manufactured by Air Products and Chemicals, Inc.; fluorinated surfactants, such as those from the ZONYL® family (e.g., ZONYL® FSO and ZONYL® FSN surfactants), manufactured by E.I. DuPont de Nemours and Company; alkoxylated surfactants such as TEGO® Wet 510 manufactured from Evonik; fluorinated POLYFOX® non-ionic surfactants (e.g., PF159 non-ionic surfactants), manufactured by Omnova; silicone surfactants, such as those from BYK® 340 series (e.g., BYK® 345, BYK® 346, BYK® 347, BYK® 348, BYK® 349) manufactured by BYK Chemie; or combinations thereof.

Examples of suitable cationic surfactants that may be used in the inkjet fixer composition include long chain amines and/or their salts, acrylated diamines, polyamines and/or their salts, quaternary ammonium salts, polyoxyethylenated long-chain amines, quaternized polyoxyethylenated long-chain amines, and/or combinations thereof.

Examples of suitable zwitterionic (amphoteric) surfactants that may be used in the inkjet fixer composition include coco-betaine, alkyl isothionates, N,N-dimethyl-N-dodecylamine oxide, N,N-dimethyl-N-tetradecyl amine oxide (i.e., myristamine oxide), N,N-dimethyl-N-hexadecyl amine oxide, N,N-dimethyl-N-octadecyl amine oxide, N,N-dimethyl-N—(Z-9-octadecenyl)-N-amine oxide, N-dodecyl-N,N-dimethyl glycine, lecithins, phospatidylethanolamine, phosphatidylcholine, and phosphatidylserine.

The amount of the surfactant that may be present in the fixer composition is 2 wt % active or less (with the lower limit being above 0) based on the total weight of the fixer composition. Whether used alone or in a combination, the total surfactant amount is within this range. In some examples, the amount of the surfactant ranges from about 0.05 wt % active to about 1.5 wt % active, or from about 0.1 wt % active to about 1 wt % active, or from about 0.2 wt % active to about 0.8 wt % active, based on the total weight of the fixer composition.

The balance of the fixer composition is water, and thus the total amount of water depends on the weight percentages of the other fixer composition components. As examples, purified water or deionized water may be used.

The fixer composition may be particularly suitable for printing via a thermal inkjet printhead, but can also be applied with a piezoelectric inkjet printhead or using an analog method. When used in a thermal inkjet printer, the viscosity of the fixer composition may be modified to range from about 1 centipoise (cP) to about 9 cP (at 20° C. to 25° C.). In some specific examples, the thermal inkjet printable fixer composition has a viscosity ranging from about 1 cP to about 3 cP. When used in a piezoelectric printer, the viscosity of the fixer composition may be modified to range from about 1 cP to about 20 cP (at 20° C. to 25° C.), depending on the viscosity of the printhead that is being used (e.g., low viscosity printheads, medium viscosity printheads, or high viscosity printheads). When applied using analog methods, the viscosity for the fixer composition may range from about 1 cP to about 1000 cP.

One specific example of the fixer composition includes (or consists of) the glycidyl amine resin in an amount ranging from about 0.5 wt % to about 12 wt % based on the total weight of the fixer composition; the acid, wherein a molar ratio of the tertiary amine group(s) of the glycidyl amine resin to the acid ranges from 1:0.5 to about 1:2; the co-solvent in an amount ranging from about 1 wt % to about 20 wt % based on the total weight of the fixer composition; and the balance of water, where the pH of the fixer composition is at, or adjusted to about 8.5 or less than 8.5.

Ink Composition

Examples of the ink composition disclosed herein include a pigment; a polymeric binder; and an aqueous ink vehicle. In some examples, the ink composition consists of the pigment; the polymeric binder; and an aqueous ink vehicle; and thus does not include any other components. In other examples, the ink composition further comprises an additive selected from the group consisting of a non-ionic or an anionic surfactant, an anti-kogation agent, an antimicrobial agent, an anti-decel agent, and combinations thereof.

Piqments

The pigment may be incorporated into the ink composition as a pigment dispersion. The pigment dispersion may include a pigment and a separate dispersant, or may include a self-dispersed pigment.

For the pigment dispersions disclosed herein, it is to be understood that the pigment and separate dispersant or the self-dispersed pigment (prior to being incorporated into the ink formulation), may be dispersed in water alone or in combination with an additional water soluble or water miscible co-solvent, such as 2-pyrrolidone, 1-(2-hydroxyethyl)-2-pyrrolidone, glycerol, 2-methyl-1,3-propanediol, 1,2-butane diol, diethylene glycol, triethylene glycol, tetraethylene glycol, or a combination thereof. It is to be understood however, that the liquid components of the pigment dispersion become part of the liquid vehicle in the inkjet ink.

Whether separately dispersed or self-dispersed, the pigment can be any of a number of primary or secondary colors, or black or white. As specific examples, the pigment may be any color, including, as examples, a cyan pigment, a magenta pigment, a yellow pigment, a black pigment, a violet pigment, a green pigment, a brown pigment, an orange pigment, a purple pigment, a white pigment, or combinations thereof.

Pigments and Separate Dispersants

Examples of the inkjet ink may include a pigment that is not self-dispersing and a separate dispersant. Examples of these pigments, as well as suitable dispersants for these pigments will now be described.

Examples of suitable white pigments include white metal oxide pigments, such as titanium dioxide (TiO₂), zinc oxide (ZnO), zirconium dioxide (ZrO₂), or the like. In one example, the white pigment is titanium dioxide. In an example, the titanium dioxide is in its rutile form.

In some examples, the white pigment may include white metal oxide pigment particles coated with silicon dioxide (SiO₂). In one example, the white metal oxide pigment content to silicon dioxide content can be from 100:3.5 to 5:1 by weight. In other examples, the white pigment may include white metal oxide pigment particles coated with silicon dioxide (SiO₂) and aluminum oxide (Al₂O₃). In one example, the white metal oxide pigment content to total silicon dioxide and aluminum oxide content can be from 50:3 to 4:1 by weight. One example of the white pigment includes TI-PURE® R960 (TiO₂ pigment powder with 5.5 wt % silica and 3.3 wt % alumina (based on pigment content)) available from DuPont. Another example of the white pigment includes TI-PURE® R931 (TiO₂ pigment powder with 10.2 wt % silica and 6.4 wt % alumina (based on pigment content)) available from DuPont.

Examples of suitable blue or cyan organic pigments include C.I. Pigment Blue 1, C.I. Pigment Blue 2, C.I. Pigment Blue 3, C.I. Pigment Blue 15, Pigment Blue 15:3, C.I. Pigment Blue 15:4, C.I. Pigment Blue 16, C.I. Pigment Blue 18, C.I. Pigment Blue 22, C.I. Pigment Blue 25, C.I. Pigment Blue 60, C.I. Pigment Blue 65, C.I. Pigment Blue 66, C.I. Vat Blue 4, and C.I. Vat Blue 60.

Examples of suitable magenta, red, or violet organic pigments include C.I. Pigment Red 1, C.I. Pigment Red 2, C.I. Pigment Red 3, C.I. Pigment Red 4, C.I. Pigment Red 5, C.I. Pigment Red 6, C.I. Pigment Red 7, C.I. Pigment Red 8, C.I. Pigment Red 9, C.I. Pigment Red 10, C.I. Pigment Red 11, C.I. Pigment Red 12, C.I. Pigment Red 14, C.I. Pigment Red 15, C.I. Pigment Red 16, C.I. Pigment Red 17, C.I. Pigment Red 18, C.I. Pigment Red 19, C.I. Pigment Red 21, C.I. Pigment Red 22, C.I. Pigment Red 23, C.I. Pigment Red 30, C.I. Pigment Red 31, C.I. Pigment Red 32, C.I. Pigment Red 37, C.I. Pigment Red 38, C.I. Pigment Red 40, C.I. Pigment Red 41, C.I. Pigment Red 42, C.I. Pigment Red 48(Ca), C.I. Pigment Red 48(Mn), C.I. Pigment Red 57(Ca), C.I. Pigment Red 57:1, C.I. Pigment Red 88, C.I. Pigment Red 112, C.I. Pigment Red 114, C.I. Pigment Red 122, C.I. Pigment Red 123, C.I. Pigment Red 144, C.I. Pigment Red 146, C.I. Pigment Red 149, C.I. Pigment Red 150, C.I. Pigment Red 166, C.I. Pigment Red 168, C.I. Pigment Red 170, C.I. Pigment Red 171, C.I. Pigment Red 175, C.I. Pigment Red 176, C.I. Pigment Red 177, C.I. Pigment Red 178, C.I. Pigment Red 179, C.I. Pigment Red 184, C.I. Pigment Red 185, C.I. Pigment Red 187, C.I. Pigment Red 202, C.I. Pigment Red 209, C.I. Pigment Red 219, C.I. Pigment Red 224, C.I. Pigment Red 245, C.I. Pigment Red 286, C.I. Pigment Violet 19, C.I. Pigment Violet 23, C.I. Pigment Violet 32, C.I. Pigment Violet 33, C.I. Pigment Violet 36, C.I. Pigment Violet 38, C.I. Pigment Violet 43, and C.I. Pigment Violet 50. Any quinacridone pigment or a co-crystal of quinacridone pigments may be used for magenta inks.

Examples of suitable yellow organic pigments include C.I. Pigment Yellow 1, C.I. Pigment Yellow 2, C.I. Pigment Yellow 3, C.I. Pigment Yellow 4, C.I. Pigment Yellow 5, C.I. Pigment Yellow 6, C.I. Pigment Yellow 7, C.I. Pigment Yellow 10, C.I. Pigment Yellow 11, C.I. Pigment Yellow 12, C.I. Pigment Yellow 13, C.I. Pigment Yellow 14, C.I. Pigment Yellow 16, C.I. Pigment Yellow 17, C.I. Pigment Yellow 24, C.I. Pigment Yellow 34, C.I. Pigment Yellow 35, C.I. Pigment Yellow 37, C.I. Pigment Yellow 53, C.I. Pigment Yellow 55, C.I. Pigment Yellow 65, C.I. Pigment Yellow 73, C.I. Pigment Yellow 74, C.I. Pigment Yellow 75, C.I. Pigment Yellow 77, C.I. Pigment Yellow 81, C.I. Pigment Yellow 83, C.I. Pigment Yellow 93, C.I. Pigment Yellow 94, C.I. Pigment Yellow 95, C.I. Pigment Yellow 97, C.I. Pigment Yellow 98, C.I. Pigment Yellow 99, C.I. Pigment Yellow 108, C.I. Pigment Yellow 109, C.I. Pigment Yellow 110, C.I. Pigment Yellow 113, C.I. Pigment Yellow 114, C.I. Pigment Yellow 117, C.I. Pigment Yellow 120, C.I. Pigment Yellow 122, C.I. Pigment Yellow 124, C.I. Pigment Yellow 128, C.I. Pigment Yellow 129, C.I. Pigment Yellow 133, C.I. Pigment Yellow 138, C.I. Pigment Yellow 139, C.I. Pigment Yellow 147, C.I. Pigment Yellow 151, C.I. Pigment Yellow 153, C.I. Pigment Yellow 154, C.I. Pigment Yellow 155, C.I. Pigment Yellow 167, C.I. Pigment Yellow 172, C.I. Pigment Yellow 180, C.I. Pigment Yellow 185, and C.I. Pigment Yellow 213.

Carbon black may be a suitable inorganic black pigment. Examples of carbon black pigments include those manufactured by Mitsubishi Chemical Corporation, Japan (such as, e.g., carbon black No. 2300, No. 900, MCF88, No. 33, No. 40, No. 45, No. 52, MA7, MA8, MA100, and No. 2200B); various carbon black pigments of the RAVEN® series manufactured by Columbian Chemicals Company, Marietta, Ga., (such as, e.g., RAVEN® 5750, RAVEN® 5250, RAVEN® 5000, RAVEN® 3500, RAVEN® 1255, and RAVEN® 700); various carbon black pigments of the REGAL® series, BLACK PEARLS® series, the MOGUL® series, or the MONARCH® series manufactured by Cabot Corporation, Boston, Mass., (such as, e.g., REGAL® 400R, REGAL® 330R, REGAL® 660R, BLACK PEARLS® 700, BLACK PEARLS® 800, BLACK PEARLS® 880, BLACK PEARLS® 1100, BLACK PEARLS® 4350, BLACK PEARLS® 4750, MOGUL® E, MOGUL® L, and ELFTEX® 410); and various black pigments manufactured by Evonik Degussa Orion Corporation, Parsippany, N.J., (such as, e.g., Color Black FW1, Color Black FW2, Color Black FW2V, Color Black FW18, Color Black FW200, Color Black S150, Color Black S160, Color Black S170, PRINTEX® 35, PRINTEX® 75, PRINTEX® 80, PRINTEX® 85, PRINTEX® 90, PRINTEX® U, PRINTEX® V, PRINTEX® 140U, Special Black 5, Special Black 4A, and Special Black 4). An example of an organic black pigment includes aniline black, such as C.I. Pigment Black 1.

Some examples of green organic pigments include C.I. Pigment Green 1, C.I. Pigment Green 2, C.I. Pigment Green 4, C.I. Pigment Green 7, C.I. Pigment Green 8, C.I. Pigment Green 10, C.I. Pigment Green 36, and C.I. Pigment Green 45.

Examples of brown organic pigments include C.I. Pigment Brown 1, C.I. Pigment Brown 5, C.I. Pigment Brown 22, C.I. Pigment Brown 23, C.I. Pigment Brown 25, C.I. Pigment Brown 41, and C.I. Pigment Brown 42.

Some examples of orange organic pigments include C.I. Pigment Orange 1, C.I. Pigment Orange 2, C.I. Pigment Orange 5, C.I. Pigment Orange 7, C.I. Pigment Orange 13, C.I. Pigment Orange 15, C.I. Pigment Orange 16, C.I. Pigment Orange 17, C.I. Pigment Orange 19, C.I. Pigment Orange 24, C.I. Pigment Orange 34, C.I. Pigment Orange 36, C.I. Pigment Orange 38, C.I. Pigment Orange 40, C.I. Pigment Orange 43, C.I. Pigment Orange 64, C.I. Pigment Orange 66, C.I. Pigment Orange 71, and C.I. Pigment Orange 73.

The average particle size of the pigments may range anywhere from about 20 nm to about 2000 nm. In some examples, the average particle size ranges from about 100 nm to about 2000 nm, from about 150 nm to about 1000 nm, from about 50 nm to about 750 nm, or from about 200 nm to about 500 nm. The term “average particle size”, as used herein, may refer to a volume-weighted mean diameter of a particle distribution.

Any of the pigments mentioned herein can be dispersed by a separate dispersant, such as a styrene (meth)acrylate dispersant, or another dispersant suitable for keeping the pigment suspended in the liquid vehicle. For example, the dispersant can be any dispersing (meth)acrylate polymer, or other type of polymer, such as a maleic polymer, a dispersant with aromatic groups and a poly(ethylene oxide) chain, or a hydrophilic polyurethane.

In one example, (meth)acrylate polymer can be a styrene-acrylic type dispersant polymer, as it can promote π-stacking between the aromatic ring of the dispersant and various types of pigments, such as copper phthalocyanine pigments, for example. In this example, the inkjet ink further comprises a styrene acrylic polymeric dispersant. In one example, the styrene-acrylic dispersant can have a weight average molecular weight (M_{w}, in g/mol or Daltons) ranging from about 2,000 to about 30,000. In another example, the styrene-acrylic dispersant can have a weight average molecular weight ranging from about 8,000 to about 28,000, from about 12,000 to about 25,000, from about 15,000 to about 25,000, from about 15,000 to about 20,000, or about 17,000. Regarding the acid number, the styrene-acrylic dispersant can have an acid number from 100 to 350, from 120 to 350, from 150 to 250, from 155 to 185, or about 172, for example. Example commercially available styrene-acrylic dispersants can include JONCRYL® 671, JONCRYL® 71, JONCRYL®96, JONCRYL® 680, JONCRYL® 683, JONCRYL® 678, JONCRYL® 690, JONCRYL® 296, JONCRYL® 696 or JONCRYL® ECO 675 (all available from BASF Corp.).

The term “(meth)acrylate” or “(meth)acrylic acid” or the like refers to monomers, copolymerized monomers, etc., that can either be acrylate or methacrylate (or a combination of both), or acrylic acid or methacrylic acid (or a combination of both). Also, in some examples, the terms “(meth)acrylate” and “(meth)acrylic acid” can be used interchangeably, as acrylates and methacrylates are salts and esters of acrylic acid and methacrylic acid, respectively. Furthermore, mention of one compound over another can be a function of pH. For examples, even if the monomer used to form the polymer was in the form of a (meth)acrylic acid during preparation, pH modifications during preparation or subsequently when added to an inkjet ink can impact the nature of the moiety as well (acid form vs. salt or ester form). Thus, a monomer or a moiety of a polymer described as (meth)acrylic acid or as (meth)acrylate should not be read so rigidly as to not consider relative pH levels, ester chemistry, and other general organic chemistry concepts.

The following are some example pigment and separate dispersant combinations: a carbon black pigment with a styrene acrylic dispersant; PB 15:3 (cyan pigment) with a styrene acrylic dispersant; PR122 (magenta) or a co-crystal of PR122 and PV19 (magenta) with a styrene acrylic dispersant or a combination of a styrene acrylic dispersant and a hydrophilic polyurethane; or PY74 (yellow) or PY155 (yellow) with a styrene acrylic dispersant.

In an example, the pigment is present in an amount ranging from about 1 wt % active to about 10 wt % active, based on a total weight of the inkjet ink. In another example, the pigment is present in the inkjet ink in an amount ranging from about 1 wt % active to about 6 wt % active of the total weight of the inkjet ink. In still another example, the pigment is present in the inkjet ink in an amount ranging from about 2 wt % active to about 6 wt % active of the total weight of the inkjet ink. When the separate dispersant is used, the separate dispersant may be present in an amount ranging from about 0.05 wt % active to about 6 wt % active of the total weight of the inkjet ink. In some examples, the ratio of pigment to separate dispersant may range from 0.5 (1:2) to 10 (10:1).

Self-Dispersed Pigments

In other examples, the ink composition includes a self-dispersed pigment, which includes a pigment and an organic group attached thereto.

Any of the pigments set forth herein may be used, such as carbon, phthalocyanine, quinacridone, azo, or any other type of organic pigment, as long as at least one organic group that is capable of dispersing the pigment is attached to the pigment.

The organic group that is attached to the pigment includes at least one aromatic group, an alkyl (e.g., C₁ to C₂₀), and an ionic or ionizable group.

The aromatic group may be an unsaturated cyclic hydrocarbon containing one or more rings and may be substituted or unsubstituted, for example with alkyl groups. Aromatic groups include aryl groups (for example, phenyl, naphthyl, anthracenyl, and the like) and heteroaryl groups (for example, imidazolyl, pyrazolyl, pyridinyl, thienyl, thiazolyl, furyl, triazinyl, indolyl, and the like).

The alkyl may be branched or unbranched, substituted or unsubstituted.

The ionic or ionizable group may be at least one phosphorus-containing group, at least one sulfur-containing group, or at least one carboxylic acid group.

In an example, the at least one phosphorus-containing group has at least one P—O bond or P═O bond, such as at least one phosphonic acid group, at least one phosphinic acid group, at least one phosphinous acid group, at least one phosphite group, at least one phosphate, diphosphate, triphosphate, or pyrophosphate groups, partial esters thereof, or salts thereof. By “partial ester thereof”, it is meant that the phosphorus-containing group may be a partial phosphonic acid ester group having the formula —PO₃RH, or a salt thereof, wherein R is an aryl, alkaryl, aralkyl, or alkyl group. By “salts thereof”, it is meant that the phosphorus-containing group may be in a partially or fully ionized form having a cationic counterion.

When the organic group includes at least two phosphonic acid groups or salts thereof, either or both of the phosphonic acid groups may be a partial phosphonic ester group. Also, one of the phosphonic acid groups may be a phosphonic acid ester having the formula —PO₃R₂, while the other phosphonic acid group may be a partial phosphonic ester group, a phosphonic acid group, or a salt thereof. In some instances, it may be desirable that at least one of the phosphonic acid groups is either a phosphonic acid, a partial ester thereof, or salts thereof. When the organic group includes at least two phosphonic acid groups, either or both of the phosphonic acid groups may be in either a partially or fully ionized form. In these examples, either or both may of the phosphonic acid groups have the formula —PO₃H₂, —PO₃H⁻ M⁺ (monobasic salt), or —PO₃⁻² M⁺² (dibasic salt), wherein M⁺ is a cation such as Na⁺, K⁺, Li⁺, or NR₄⁺, wherein R, which can be the same or different, represents hydrogen or an organic group such as a substituted or unsubstituted aryl and/or alkyl group.

As other examples, the organic group may include at least one geminal bisphosphonic acid group, partial esters thereof, or salts thereof. By “geminal”, it is meant that the at least two phosphonic acid groups, partial esters thereof, or salts thereof are directly bonded to the same carbon atom. Such a group may also be referred to as a 1,1-diphosphonic acid group, partial ester thereof, or salt thereof.

An example of a geminal bisphosphonic acid group may have the formula —CQ(PO₃H₂)₂, or may be partial esters thereof or salts thereof. Q is bonded to the geminal position and may be H, R, OR, SR, or NR₂ wherein R, which can be the same or different when multiple are present, is selected from H, a C₁-C₁₈ saturated or unsaturated, branched or unbranched alkyl group, a C₁-C₁₈ saturated or unsaturated, branched or unbranched acyl group, an aralkyl group, an alkaryl group, or an aryl group. For examples, Q may be H, R, OR, SR, or NR₂, wherein R, which can be the same or different when multiple are present, is selected from H, a C₁-C₆ alkyl group, or an aryl group. As specific examples, Q is H, OH, or NH₂. Another example of a geminal bisphosphonic acid group may have the formula —(CH₂)ₙCQ(PO₃H₂)₂, or may be partial esters thereof or salts thereof, wherein Q is as described above and n is 0 to 9, such as 1 to 9. In some specific examples, n is 0 to 3, such as 1 to 3, or n is either 0 or 1.

Still another example of a geminal bisphosphonic acid group may have the formula —X—(CH₂)ₙCQ(PO₃H₂)₂, or may be partial esters thereof or salts thereof, wherein Q and n are as described above and X is an arylene, heteroarylene, alkylene, vinylidene, alkarylene, aralkylene, cyclic, or heterocyclic group. In specific examples, X is an arylene group, such as a phenylene, naphthalene, or biphenylene group, which may be further substituted with any group, such as one or more alkyl groups or aryl groups. When X is an alkylene group, examples include substituted or unsubstituted alkylene groups, which may be branched or unbranched and can be substituted with one or more groups, such as aromatic groups. Examples of X include C₁-C₁₂ groups like methylene, ethylene, propylene, or butylene. X may be directly attached to the pigment, meaning there are no additional atoms or groups from the attached organic group between the pigment and X. X may also be further substituted with one or more functional groups. Examples of functional groups include R′, OR′, COR′, COOR′, OCOR′, carboxylates, halogens, CN, NR′₂, SO₃H, sulfonates, sulfates, NR′(COR′), CONR′₂, imides, NO₂, phosphates, phosphonates, N═NR′, SOR′, NR′SO₂R′, and SO₂NR′₂, wherein R′, which can be the same or different when multiple are present, is independently selected from hydrogen, branched or unbranched C₁-C₂₀ substituted or unsubstituted, saturated or unsaturated hydrocarbons, e.g., alkyl, alkenyl, alkynyl, substituted or unsubstituted aryl, substituted or unsubstituted heteroaryl, substituted or unsubstituted alkaryl, or substituted or unsubstituted aralkyl.

Yet another example of a geminal bisphosphonic acid group may have the formula —X-Sp—(CH₂)ₙCQ(PO₃H₂)₂, or may be partial esters thereof or salt thereof, wherein X, Q, and n are as described above. “Sp” is a spacer group, which, as used herein, is a link between two groups. Sp can be a bond or a chemical group. Examples of chemical groups include, but are not limited to, —CO₂—, —O₂C—, —CO—, —OSO₂—, —SO₃—, —SO₂—, —SO₂C₂H₄O—, —SO₂C₂H₄S—, —SO₂C₂H₄NR″—, —O—, —S—, —NR″—, —NR″CO—, —CONR″—, —NR″CO₂—, —O₂CNR″—, —NR″CONR″—, —N(COR″)CO—, —CON(COR″)—, —NR″COCH(CH₂CO₂R″)— and cyclic imides therefrom, —NR″COCH₂CH(CO₂R″)— and cyclic imides therefrom, —CH(CH₂CO₂R″)CONR″— and cyclic imides therefrom, —CH(CO₂R″)CH₂CONR″ and cyclic imides therefrom (including phthalimide and maleimides of these), sulfonamide groups (including —SO₂NR″— and —NR″SO₂— groups), arylene groups, alkylene groups and the like. R″, which can be the same or different when multiple are included, represents H or an organic group such as a substituted or unsubstituted aryl or alkyl group. In the example formula —X-Sp—(CH₂)ₙCQ(PO₃H₂)₂, the two phosphonic acid groups or partial esters or salts thereof are bonded to X through the spacer group Sp. Sp may be —CO₂—, —O₂C—, —O—, —NR″—, —NR″CO—, or —CONR″—, —SO₂NR″—, —SO₂CH₂CH₂NR″—, —SO₂CH₂CH₂O—, or —SO₂CH₂CH₂S— wherein R″ is H or a C₁-C₆ alkyl group.

Still a further example of a geminal bisphosphonic acid group may have the formula —N—[(CH₂)ₘ(PO₃H₂)]₂, partial esters thereof, or salts thereof, wherein m, which can be the same or different, is 1 to 9. In specific examples, m is 1 to 3, or 1 or 2. As another example, the organic group may include at least one group having the formula —(CH₂)n-N—[(CH₂)ₘ(PO₃H₂)]₂, partial esters thereof, or salts thereof, wherein n is 0 to 9, such as 1 to 9, or 0 to 3, such as 1 to 3, and m is as defined above. Also, the organic group may include at least one group having the formula —X—(CH₂)ₙ—N—[(CH₂)ₘ(PO₃H₂)]₂, partial esters thereof, or salts thereof, wherein X, m, and n are as described above, and, in an example, X is an arylene group. Still further, the organic group may include at least one group having the formula —X-Sp—(CH₂)ₙ—N—[(CH₂)ₘ(PO₃H₂)]₂, partial esters thereof, or salts thereof, wherein X, m, n, and Sp are as described above.

Yet a further example of a geminal bisphosphonic acid group may have the formula —CR═C(PO₃H₂)₂, partial esters thereof, or salts thereof. In this example, R can be H, a C₁-C₁₈ saturated or unsaturated, branched or unbranched alkyl group, a C₁-C₁₈ saturated or unsaturated, branched or unbranched acyl group, an aralkyl group, an alkaryl group, or an aryl group. In an example, R is H, a C₁-C₆ alkyl group, or an aryl group.

The organic group may also include more than two phosphonic acid groups, partial esters thereof, or salts thereof, and may, for example include more than one type of group (such as two or more) in which each type of group includes at least two phosphonic acid groups, partial esters thereof, or salts thereof. For example, the organic group may include a group having the formula —X—[CQ(PO₃H₂)₂]P, partial esters thereof, or salts thereof. In this example, X and Q are as described above. In this formula, p is 1 to 4, e.g., 2.

In addition, the organic group may include at least one vicinal bisphosphonic acid group, partial ester thereof, or salts thereof, meaning that these groups are adjacent to each other. Thus, the organic group may include two phosphonic acid groups, partial esters thereof, or salts thereof bonded to adjacent or neighboring carbon atoms. Such groups are also sometimes referred to as 1,2-diphosphonic acid groups, partial esters thereof, or salts thereof. The organic group including the two phosphonic acid groups, partial esters thereof, or salts thereof may be an aromatic group or an alkyl group, and therefore the vicinal bisphosphonic acid group may be a vicinal alkyl or a vicinal aryl diphosphonic acid group, partial ester thereof, or salts thereof. For example, the organic group may be a group having the formula —C₆H₃—(PO₃H₂)₂, partial esters thereof, or salts thereof, wherein the acid, ester, or salt groups are in positions ortho to each other.

In other examples, the ionic or ionizable group (of the organic group attached to the pigment) is a sulfur-containing group. The at least one sulfur-containing group has at least one S═O bond, such as a sulfinic acid group or a sulfonic acid group. Salts of sulfinic or sulfonic acids may also be used, such as —SO₃⁻ X⁺, where X is a cation, such as Na⁺, H⁺, K⁺, NH₄⁺, Li⁺, Ca²⁺, Mg⁺, etc.

When the ionic or ionizable group is a carboxylic acid group, the group may be COOH or a salt thereof, such as —COO—X⁺, —(COO—X⁺)₂, or —(COO—X⁺)₃.

Examples of the self-dispersed pigments are commercially available as dispersions. Suitable commercially available self-dispersed pigment dispersions include those of the CAB-O-JET® 200 Series, manufactured by Cabot Corporation. Some specific examples include CAB-O-JET® 200 (black pigment), CAB-O-JET®250C (cyan pigment), CAB-O-JET® 260M or 265M (magenta pigment) and CAB-O-JET® 270 (yellow pigment)). Other suitable commercially available self-dispersed pigment dispersions include those of the CAB-O-JET® 400 Series, manufactured by Cabot Corporation. Some specific examples include CAB-O-JET® 400 (black pigment), CAB-O-JET® 450C (cyan pigment), CAB-O-JET® 465M (magenta pigment) and CAB-O-JET® 470Y (yellow pigment)). Still other suitable commercially available self-dispersed pigment dispersions include those of the CAB-O-JET® 300 Series, manufactured by Cabot Corporation. Some specific examples include CAB-O-JET®300 (black pigment) and CAB-O-JET® 352K (black pigment).

The self-dispersed pigment may be present in an amount ranging from about 1 wt % active to about 10 wt % active based on a total weight of the ink composition. In an example, the self-dispersed pigment is present in an amount ranging from about 1 wt % active to about 6 wt % active based on a total weight of the ink composition. In another example, the self-dispersed pigment is present in an amount ranging from about 2 wt % active to about 5 wt % active based on a total weight of the ink composition. In yet another example, the self-dispersed pigment is present in an amount of about 3 wt % based on the total weight of the ink composition. In still another example, the self-dispersed pigment is present in an amount of about 5 wt % active based on the total weight of the ink composition.

Polymeric Binder

The ink composition also includes a polymeric binder. Examples of the polymeric binder may be one of: a polyurethane-based binder selected from the group consisting of a polyester-polyurethane binder, a polyether-polyurethane binder, and a polycarbonate-polyurethane binder; or an acrylic latex binder.

In an example, the ink composition includes the polyester-polyurethane binder. In an example, the polyester-polyurethane binder is a sulfonated polyester-polyurethane binder. The sulfonated polyester-polyurethane binder can include diaminesulfonate groups. In an example, the polymeric binder is the polyester-polyurethane binder, the polyester-polyurethane binder is a sulfonated polyester-polyurethane binder, and is one of: i) an aliphatic compound including multiple saturated carbon chain portions ranging from C₄ to C₁₀ in length, and that is devoid of an aromatic moiety, or ii) an aromatic compound including an aromatic moiety and multiple saturated carbon chain portions ranging from C₄ to C₁₀ in length.

In one example, the sulfonated polyester-polyurethane binder can be anionic. In further detail, the sulfonated polyester-polyurethane binder can also be aliphatic, including saturated carbon chains as part of the polymer backbone or as a side-chain thereof, e.g., C₂ to C₁₀, C₃ to C₈, or C₃ to C₆ alkyl. These polyester-polyurethane binders can be described as “alkyl” or “aliphatic” because these carbon chains are saturated and because they are devoid of aromatic moieties. An example of an anionic aliphatic polyester-polyurethane binder that can be used is IMPRANIL® DLN-SD (Mw 133,000; Acid Number 5.2; Tg −47° C.; Melting Point 175-200° C.) from Covestro. Example components used to prepare the IMPRANIL® DLN-SD or other similar anionic aliphatic polyester-polyurethane binders can include pentyl glycols (e.g., neopentyl glycol); C₄ to C₁₀ alkyldiol (e.g., hexane-1,6-diol); C₄ to C₁₀ alkyl dicarboxylic acids (e.g., adipic acid); C₄ to C₁₀ alkyl diisocyanates (e.g., hexamethylene diisocyanate (HDI)); diamine sulfonic acids (e.g., 2-[(2-aminoethyl)amino]ethanesulfonic acid); etc.

Alternatively, the sulfonated polyester-polyurethane binder can be aromatic (or include an aromatic moiety) and can include aliphatic chains. An example of an aromatic polyester-polyurethane binder that can be used is DISPERCOLL® U42. Example components used to prepare the DISPERCOLL® U42 or other similar aromatic polyester-polyurethane binders can include aromatic dicarboxylic acids, e.g., phthalic acid; C₄ to C₁₀ alkyl dialcohols (e.g., hexane-1,6-diol); C₄ to C₁₀ alkyl diisocyanates (e.g., hexamethylene diisocyanate (HDI)); diamine sulfonic acids (e.g., 2-[(2-aminoethyl)amino]ethanesulfonic acid); etc.

Other types of polyester-polyurethanes can also be used, including IMPRANIL® DL 1380, which can be somewhat more difficult to jet from thermal inkjet printheads compared to IMPRANIL® DLN-SD and DISPERCOLL® U42, but still can be acceptably jetted in some examples, and can also provide acceptable washfastness results on a variety of fabric types.

The polyester-polyurethane binders disclosed herein may have a weight average molecular weight (Mw, g/mol or Daltons) ranging from about 20,000 to about 300,000. In some examples of the inkjet ink, the polymeric binder is the polyester-polyurethane binder, and the polyester-polyurethane binder has a weight average molecular weight ranging from about 20,000 Mw to about 300,000 Mw. As examples, the weight average molecular weight can range from about 50,000 to about 500,000, from about 100,000 to about 400,000, or from about 150,000 to about 300,000.

The polyester-polyurethane binders disclosed herein may have an acid number that ranges from about 1 mg KOH/g to about 50 mg KOH/g. In some examples of the inkjet ink, the polymeric binder is the polyester-polyurethane binder, and the polyester-polyurethane binder has an acid number that ranges from about 1 mg KOH/g to about 50 mg KOH/g. As other examples, the acid number of the polyester-polyurethane binder can range from about 1 mg KOH/g to about 200 mg KOH/g, from about 2 mg KOH/g to about 100 mg KOH/g, or from about 3 mg KOH/g to about 50 mg KOH/g.

As used herein, the term “acid number” refers to the mass of potassium hydroxide (KOH) in milligrams that is used to neutralize one (1) gram of a particular substance. The test for determining the acid number of a particular substance may vary, depending on the substance. To determine the acid number of the polyester-polyurethane binder, a known amount of a sample of the polyester-polyurethane binder may be dispersed in water and the aqueous dispersion may be titrated with a polyelectrolyte titrant of a known concentration. In this example, a current detector for colloidal charge measurement may be used. An example of a current detector is the Mütek PCD-05 Smart Particle Charge Detector (available from BTG). The current detector measures colloidal substances in an aqueous sample by detecting the streaming potential as the sample is titrated with the polyelectrolyte titrant to the point of zero charge. An example of a suitable polyelectrolyte titrant is poly(diallyldimethylammonium chloride) (i.e., PolyDADMAC). It is to be understood that any suitable test for a particular component may be used.

The average particle size of the polyester-polyurethane binders disclosed herein may range from about 20 nm to about 500 nm. As examples, the sulfonated polyester-polyurethane binder can have an average particle size ranging from about 20 nm to about 500 nm, from about 50 nm to about 350 nm, or from about 100 nm to about 350 nm. The particle size of any solids herein, including the average particle size of the dispersed polymer binder, can be determined using a NANOTRAC® Wave device, from Microtrac, e.g., NANOTRAC® Wave II or NANOTRAC® 150, etc., which measures particles size using dynamic light scattering. Average particle size can be determined using particle size distribution data generated by the NANOTRAC® Wave device. As mentioned, the term “average particle size” may refer to a volume-weighted mean diameter of a particle distribution.

Other examples of the ink composition include a polyether-polyurethane binder. Examples of polyether-polyurethanes that may be used include IMPRANIL® LP DSB 1069, IMPRANIL® DLE, IMPRANIL® DAH, or IMPRANIL® DL 1116 (Covestro (Germany)); or HYDRAN® WLS-201 or HYDRAN® WLS-201K (DIC Corp. (Japan)); or TAKELAC® W-6061T or TAKELAC® WS-6021 (Mitsui (Japan)).

Still other examples of the ink composition include a polycarbonate-polyurethane binder. Examples of polycarbonate-polyurethanes that may be used as the polymeric binder include IMPRANIL® DLC-F or IMPRANIL® DL 2077 (Covestro (Germany)); or HYDRAN® WLS-213 (DIC Corp. (Japan)); or TAKELAC® W-6110 (Mitsui (Japan)).

Additional examples of the ink composition include an acrylic latex binder. The acrylic latex binder includes latex particles. As used herein, the term “latex” refers to a stable dispersion of polymer particles in an aqueous medium. As such, the polymer (latex) particles may be dispersed in water or water and a suitable co-solvent. This aqueous latex dispersion may be incorporated, with the pigment dispersion disclosed herein, into a suitable liquid vehicle to form examples of the inkjet ink.

In some examples, the latex particles can include a polymerization product of monomers including: a copolymerizable surfactant; an aromatic monomer selected from styrene, an aromatic (meth)acrylate monomer, and an aromatic (meth)acrylamide monomer; and multiple aliphatic (meth)acrylate monomers or multiple aliphatic (meth)acrylamide monomers. The term “(meth)” indicates that the acrylamide, the acrylate, etc., may or may not include the methyl group. In one example, the latex particles can include a polymerization product of a copolymerizable surfactant such as HITENOL™ BC-10, BC-30, KH-05, or KH-10. In another example, the latex particles can include a polymerization product of styrene, methyl methacrylate, butyl acrylate, and methacrylic acid.

In another particular example, the latex particles can include a first heteropolymer phase and a second heteropolymer phase. The first heteropolymer phase is a polymerization product of multiple aliphatic (meth)acrylate monomers or multiple aliphatic (meth)acrylamide monomers. The second heteropolymer phase can be a polymerization product of an aromatic monomer with a cycloaliphatic monomer, wherein the aromatic monomer is an aromatic (meth)acrylate monomer or an aromatic (meth)acrylamide monomer, and wherein the cycloaliphatic monomer is a cycloaliphatic (meth)acrylate monomer or a cycloaliphatic (meth)acrylamide monomer. The second heteropolymer phase can have a higher glass transition temperature than the first heteropolymer phase. The first heteropolymer composition may be considered a soft polymer composition and the second heteropolymers composition may be considered a hard polymer composition.

The two phases can be physically separated in the latex particles, such as in a core-shell configuration, a two-hemisphere configuration, smaller spheres of one phase distributed in a larger sphere of the other phase, interlocking strands of the two phases, and so on.

The first heteropolymer composition can be present in the latex particles in an amount ranging from about 15 wt % to about 70 wt % of a total weight of the polymer (latex) particle and the second heteropolymer composition can be present in an amount ranging from about 30 wt % to about 85 wt % of the total weight of the polymer particle. In other examples, the first heteropolymer composition can be present in an amount ranging from about 30 wt % to about 40 wt % of a total weight of the polymer particle and the second heteropolymer composition can be present in an amount ranging from about 60 wt % to about 70 wt % of the total weight of the polymer particle. In one specific example, the first heteropolymer composition can be present in an amount of about 35 wt % of a total weight of the polymer particle and the second heteropolymers composition can be present in an amount of about 65 wt % of the total weight of the polymer particle.

As mentioned herein, the first heteropolymer phase can be polymerized from two or more aliphatic (meth)acrylate ester monomers or two or more aliphatic (meth)acrylamide monomers. The aliphatic (meth)acrylate ester monomers may be linear aliphatic (meth)acrylate ester monomers and/or cycloaliphatic (meth)acrylate ester monomers. Examples of the linear aliphatic (meth)acrylate ester monomers can include ethyl acrylate, ethyl methacrylate, benzyl acrylate, benzyl methacrylate, propyl acrylate, propyl methacrylate, isopropyl acrylate, isopropyl methacrylate, butyl acrylate, butyl methacrylate, isobutyl acrylate, isobutyl methacrylate, hexyl acrylate, hexyl methacrylate, isooctyl acrylate, isooctyl methacrylate, octadecyl acrylate, octadecyl methacrylate, lauryl acrylate, lauryl methacrylate, hydroxyethyl acrylate, hydroxyethyl methacrylate, hydroxyhexyl acrylate, hydroxyhexyl methacrylate, hydroxyoctadecyl acrylate, hydroxyoctadecyl methacrylate, hydroxylauryl methacrylate, hydroxylauryl acrylate, 2-ethylhexyl acrylate, 2-ethylhexyl methacrylate, and combinations thereof. Examples of the cycloaliphatic (meth)acrylate ester monomers can include cyclohexyl acrylate, cyclohexyl methacrylate, methylcyclohexyl acrylate, methylcyclohexyl methacrylate, trimethylcyclohexyl acrylate, trimethylcyclohexyl methacrylate, tert-butylcyclohexyl acrylate, tert-butylcyclohexyl methacrylate, and combinations thereof.

Also as mentioned herein, the second heteropolymer phase can be polymerized from a cycloaliphatic monomer and an aromatic monomer. The cycloaliphatic monomer can be a cycloaliphatic (meth)acrylate monomer or a cycloaliphatic (meth)acrylamide monomer. The aromatic monomer can be an aromatic (meth)acrylate monomer or an aromatic (meth)acrylamide monomer. The cycloaliphatic monomer of the second heteropolymer phase can be cyclohexyl acrylate, cyclohexyl methacrylate, methylcyclohexyl acrylate, methylcyclohexyl methacrylate, trimethylcyclohexyl acrylate, trimethylcyclohexyl methacrylate, tert-butylcyclohexyl acrylate, tert-butylcyclohexyl methacrylate, or a combination thereof. In still further examples, the aromatic monomer of the second heteropolymer phase can be 2-phenoxyethyl methacrylate, 2-phenoxyethyl acrylate, phenyl propyl methacrylate, phenyl propyl acrylate, benzyl methacrylate, benzyl acrylate, phenylethyl methacrylate, phenylethyl acrylate, benzhydryl methacrylate, benzhydryl acrylate, 2-hydroxy-3-phenoxypropyl acrylate, 2-hydroxy-3-phenoxypropyl methacrylate, N-benzyl methacrylamide, N-benzyl acrylamide, N,N-diphenyl methacrylamide, N,N-diphenyl acrylamide, naphthyl methacrylate, naphthyl acrylate, phenyl methacrylate, phenyl acrylate, or a combination thereof.

The latex particles can have a particle size ranging from 20 nm to 500 nm, from 50 nm to 350 nm, or from 150 nm to 270 nm.

In some examples, the latex particles can be prepared by flowing multiple monomer streams into a reactor. An initiator can also be included in the reactor. The initiator may be selected from a persulfate, such as a metal persulfate or an ammonium persulfate. In some examples, the initiator may be selected from a sodium persulfate, ammonium persulfate or potassium persulfate. The preparation process may be performed in water, resulting in the aqueous latex dispersion.

In some examples of the ink composition, the polymeric binder is present in an amount ranging from about 2 wt % active to about 15 wt % active, based on a total weight of the ink composition. In other examples, the polymeric binder can be present, in the ink composition, in an amount ranging from about from about 3 wt % active to about 11 wt % active, or from about 4 wt % active to about 10 wt % active, or from about 5 wt % active to about 9 wt % active, each of which is based on the total weight of the ink composition.

The polymeric binder (prior to being incorporated into the ink composition) may be dispersed in water alone or in combination with an additional water soluble or water miscible co-solvent, such as those described for the pigment dispersion. It is to be understood however, that the liquid components of the binder dispersion become part of the liquid vehicle in the ink composition.

Aqueous Ink Vehicle

In addition to the pigment and the polymeric binder, the ink composition includes a liquid vehicle.

As used herein, the term “aqueous ink vehicle” may refer to the liquid with which the pigment (dispersion) and polymeric binder (dispersion) are mixed to form a thermal or a piezoelectric inkjet ink(s) composition. A wide variety of vehicles may be used with the ink composition(s) of the present disclosure. The liquid vehicle may include water and any of: a co-solvent, an anti-kogation agent, an anti-decel agent, a surfactant, an antimicrobial agent, a pH adjuster, or combinations thereof. In an example of the ink composition, the vehicle includes water and a co-solvent. In another example, the vehicle consists of water and the co-solvent, the anti-kogation agent, the anti-decel agent, the surfactant, the antimicrobial agent, a pH adjuster, or a combination thereof. In still another example, the vehicle consists of the anti-kogation agent, the anti-decel agent, the surfactant, the antimicrobial agent, a pH adjuster, and water.

The vehicle may include co-solvent(s). In an example, the vehicle includes glycerol. Other examples of co-solvents include alcohols, amides, esters, ketones, lactones, and ethers. In additional detail, the co-solvent may include aliphatic alcohols, aromatic alcohols, diols, glycol ethers, polyglycol ethers, caprolactams, formamides, acetamides, and long chain alcohols. Examples of such compounds include primary aliphatic alcohols, secondary aliphatic alcohols, 1,2-alcohols, 1,3-alcohols, 1,5-alcohols, ethylene glycol alkyl ethers, propylene glycol alkyl ethers (e.g., DOWANOL™ TPM (from Dow Chemical), higher homologs (C₆-C₁₂) of polyethylene glycol alkyl ethers, N-alkyl caprolactams, unsubstituted caprolactams, both substituted and unsubstituted formamides, both substituted and unsubstituted acetamides, and the like. Specific examples of alcohols may include ethanol, isopropyl alcohol, butyl alcohol, and benzyl alcohol. Other specific examples include 2-ethyl-2-(hydroxymethyl)-1,3-propane diol (EPHD), dimethyl sulfoxide, sulfolane, and/or alkyldiols such as 1,2-hexanediol.

The co-solvent may also be a polyhydric alcohol or a polyhydric alcohol derivative. Examples of polyhydric alcohols may include ethylene glycol, diethylene glycol, propylene glycol, butylene glycol, triethylene glycol, 1,5-pentanediol, 1,2-hexanediol, 1,2,6-hexanetriol, glycerin, trimethylolpropane, and xylitol. Examples of polyhydric alcohol derivatives may include an ethylene oxide adduct of diglycerin.

The co-solvent may also be a nitrogen-containing solvent. Examples of nitrogen-containing solvents may include 2-pyrrolidone, 1-(2-hydroxyethyl)-2-pyrrolidone, N-methyl-2-pyrrolidone, cyclohexylpyrrolidone, and triethanolamine.

The co-solvent(s) may be present in the ink composition in an amount ranging from about 4 wt % to about 30 wt % (based on the total weight of the ink composition).

An anti-kogation agent may also be included in the vehicle of the ink composition. Anti-kogation agent(s) is/are included to assist in preventing the buildup of kogation. In some examples, the anti-kogation agent may improve the jettability of the ink composition. Examples of suitable anti-kogation agents in the ink composition include the phosphate ester surfactants described herein for the fixer composition. Other suitable anti-kogation agents include dextran 500k or DISPERSOGEN® LFH (polymeric dispersing agent with aromatic anchoring groups, acid form, anionic, from Clariant), etc.

The anti-kogation agent may be present in the ink composition in an amount ranging from about 0.1 wt % active to about 1.5 wt % active, based on the total weight of the ink composition. In an example, the anti-kogation agent is present in an amount of about 0.5 wt % active, based on the total weight of the ink composition.

The vehicle may include anti-decel agent(s). The anti-decel agent may function as a humectant. Decel refers to a decrease in drop velocity over time with continuous firing. In the examples disclosed herein, the anti-decel agent (s) is/are included to assist in preventing decel. In some examples, the anti-decel agent may improve the jettability of the ink composition. An example of a suitable anti-decel agent is ethoxylated glycerin having the following formula:

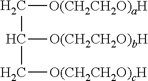

in which the total of a+b+c ranges from about 5 to about 60, or in other examples, from about 20 to about 30. An example of the ethoxylated glycerin is LIPONIC® EG-1 (LEG-1, glycereth-26, a+b+c=26, available from Lipo Chemicals).

The anti-decel agent(s) may be present in an amount ranging from about 0.2 wt % active to about 5 wt % active (based on the total weight of the ink composition). In an example, the anti-decel agent is present in the inkjet ink in an amount of about 1 wt % active, based on the total weight of the ink composition.

The liquid vehicle of the ink composition may also include surfactant(s). The surfactant in the ink composition may include anionic and/or non-ionic surfactants. Examples of the anionic surfactant may include alkylbenzene sulfonate, alkylphenyl sulfonate, alkylnaphthalene sulfonate, higher fatty acid salt, sulfate ester salt of higher fatty acid ester, sulfonate of higher fatty acid ester, sulfate ester salt and sulfonate of higher alcohol ether, higher alkyl sulfosuccinate, polyoxyethylene alkylether carboxylate, polyoxyethylene alkylether sulfate, alkyl phosphate, and polyoxyethylene alkyl ether phosphate. Specific examples of the anionic surfactant may include dodecylbenzenesulfonate, isopropylnaphthalenesulfonate, monobutylphenylphenol monosulfonate, monobutylbiphenyl sulfonate, monobutylbiphenylsulfonate, and dibutylphenylphenol disulfonate. Examples of the non-ionic surfactant may include polyoxyethylene alkyl ether, polyoxyethylene alkyl phenyl ether, polyoxyethylene fatty acid ester, sorbitan fatty acid ester, polyoxyethylene sorbitan fatty acid ester, polyoxyethylene sorbitol fatty acid ester, glycerin fatty acid ester, polyoxyethylene glycerin fatty acid ester, polyglycerin fatty acid ester, polyoxyethylene alkylamine, polyoxyethylene fatty acid amide, alkylalkanolamide, polyethylene glycol polypropylene glycol block copolymer, acetylene glycol, and a polyoxyethylene adduct of acetylene glycol. Specific examples of the non-ionic surfactant may include polyoxyethylenenonyl phenylether, polyoxyethyleneoctyl phenylether, and polyoxyethylenedodecyl. Further examples of the non-ionic surfactant may include silicon surfactants such as a polysiloxane oxyethylene adduct; fluorine surfactants such as perfluoroalkylcarboxylate, perfluoroalkyl sulfonate, and oxyethyleneperfluoro alkylether; and biosurfactants such as spiculisporic acid, rhamnolipid, and lysolecithin.

In some examples, the vehicle may include a silicone-free alkoxylated alcohol surfactant such as, for example, TEGO® Wet 510 (EvonikTegoChemie GmbH) and/or a self-emulsifiable wetting agent based on acetylenic diol chemistry, such as, for example, SURFYNOL® SE-F (Air Products and Chemicals, Inc.). Other suitable commercially available surfactants include SURFYNOL® 465 (ethoxylatedacetylenic diol), SURFYNOL® 440 (an ethoxylated low-foam wetting agent) SURFYNOL® CT-211 (now CARBOWET® GA-211, non-ionic, alkylphenylethoxylate and solvent free), and SURFYNOL® 104 (non-ionic wetting agent based on acetylenic diol chemistry), (all of which are from Air Products and Chemicals, Inc.); ZONYL® FSO (a.k.a. CAPSTONE®, which is a water-soluble, ethoxylated non-ionic fluorosurfactant from Dupont); TERGITOL® TMN-3 and TERGITOL® TMN-6 (both of which are branched secondary alcohol ethoxylate, non-ionic surfactants), and TERGITOL® 15-S-3, TERGITOL® 15-S-5, and TERGITOL® 15-S-7 (each of which is a secondary alcohol ethoxylate, non-ionic surfactant) (all of the TERGITOL® surfactants are available from The Dow Chemical Co.); and BYK® 345, BYK® 346, BYK® 347, BYK® 348, BYK® 349 (each of which is a silicone surfactant) (all of which are available from BYK Chemie).

In any of the examples disclosed herein, the surfactant may be present in an amount ranging from about 0.01 wt % active to about 5 wt % active (based on the total weight of the ink composition). Whether used alone or in combination, the total amount of surfactant(s) is within the given range. In an example, the surfactant is present in the ink composition in an amount ranging from about 0.05 wt % active to about 3 wt % active, based on the total weight of the ink composition.

The ink vehicle may also include antimicrobial agent(s). Antimicrobial agents are also known as biocides and/or fungicides. Examples of suitable antimicrobial agents include the NUOSEPT® (Ashland Inc.), UCARCIDE™ or KORDEK™ or ROCIMA™ (Dow Chemical Co.), PROXEL® (Arch Chemicals) series, ACTICIDE® B20 and ACTICIDE® M20 and ACTICIDE® MBL (blends of 2-methyl-4-isothiazolin-3-one (MIT), 1,2-benzisothiazolin-3-one (BIT) and Bronopol) (Thor Chemicals), AXIDE™ (Planet Chemical), NIPACIDE™ (Clariant), blends of 5-chloro-2-methyl-4-isothiazolin-3-one (CIT or CMIT) and MIT under the tradename KATHON™ (Dow Chemical Co.), and combinations thereof.

In an example, the total amount of antimicrobial agent(s) in the inkjet ink ranges from about 0.01 wt % active to about 0.05 wt % active (based on the total weight of the ink composition). In another example, the total amount of antimicrobial agent(s) in the inkjet ink is about 0.044 wt % active (based on the total weight of the ink composition). In some instances, the antimicrobial agent may be present in the pigment dispersion that is mixed with the vehicle.

The ink composition may also include a pH adjuster. A pH adjuster may be included in the ink composition to achieve a desired pH of greater than 7. Suitable pH ranges for examples of the ink composition can be from greater than pH 7 to pH 11, from greater than pH 7 to pH 10, from pH 7.2 to pH 10, from pH 7.5 to pH 10, from pH 8 to pH 10, 7 to pH 9, from pH 7.2 to pH 9, from pH 7.5 to pH 9, from pH 8 to pH 9, from 7 to pH 8.5, from pH 7.2 to pH 8.5, from pH 7.5 to pH 8.5, from pH 8 to pH 8.5, from 7 to pH 8, from pH 7.2 to pH 8, or from pH 7.5 to pH 8. At these pH values, the hydroxide of the azetidinium and the oxygen of the epoxide group (in the fixer composition) are more reactive, and thus readily react or interaction with group(s) in the ink composition and/or in the textile fabric.

The type and amount of pH adjuster that is added to the ink composition may depend upon the initial pH of the ink composition and the desired final pH of the ink composition. If the initial pH is too high, an acid may be added to lower the pH, and if the initial pH is too low, a base may be added increase the pH. Any suitable acid or base (such as those described herein for the fixer composition) may be used.

In an example, the total amount of pH adjuster(s) in the ink composition ranges from greater than 0 wt % to about 0.1 wt % (based on the total weight of the ink composition). In another example, the total amount of pH adjuster(s) in the fixer composition about 0.03 wt % (based on the total weight of the ink composition).

In some instances, other suitable inkjet ink additives may be included in the ink composition, such as sequestering agents (e.g., EDTA (ethylene diamine tetra acetic acid) to eliminate the deleterious effects of heavy metal impurities, and viscosity modifiers to modify properties of the ink as desired.

The balance of the ink composition is water. In an example, purified water or deionized water may be used. The water included in the inkjet ink may be: i) part of the pigment dispersion, and/or binder dispersion, ii) part of the liquid vehicle, iii) added to a mixture of the pigment dispersion, and/or binder dispersion and the ink vehicle, or iv) a combination thereof. In examples where the ink composition is a thermal inkjet ink, the liquid vehicle includes at least 70% by weight of water. In examples where the ink composition is a piezoelectric inkjet ink, the liquid vehicle is a solvent based vehicle including at least 50% by weight of the co-solvent.

One specific example of the ink composition includes the pigment in an amount ranging from about 1 wt % active to about 10 wt % active based on the total weight of the ink composition; the polymeric binder in an amount ranging from about 2 wt % active to about 15 wt % active of the total weight of the ink composition; and the aqueous ink vehicle, which includes water, an organic solvent (e.g., the co-solvent disclosed herein), and optionally an additive selected from the group consisting of a non-ionic surfactant, an anti-kogation agent, an antimicrobial agent, an anti-decel agent, and combinations thereof.

Textile Fabrics

The textile fabric may be selected from the group consisting of polyester fabrics, polyester blend fabrics, cotton fabrics, cotton blend fabrics, nylon fabrics, nylon blend fabrics, silk fabrics, silk blend fabrics, wool fabrics, wool blend fabrics, and combinations thereof. In a further example, the textile fabric is selected from the group consisting of cotton fabrics and cotton blend fabrics.

It is to be understood that organic textile fabrics and/or inorganic textile fabrics may be used for the textile fabric. Some types of fabrics that can be used include various fabrics of natural and/or synthetic fibers. It is to be understood that the polyester fabrics may be a polyester coated surface. The polyester blend fabrics may be blends of polyester and other materials (e.g., cotton, linen, etc.). In another example, the textile fabric may be selected from nylons (polyamides) or other synthetic fabrics.

Example natural fiber fabrics that can be used include treated or untreated natural fabric textile substrates, e.g., wool, cotton, silk, linen, jute, flax, hemp, rayon fibers, thermoplastic aliphatic polymeric fibers derived from renewable resources (e.g. cornstarch, tapioca products, sugarcanes), etc. Example synthetic fibers used in the textile fabric/substrate can include polymeric fibers such as nylon fibers, polyvinyl chloride (PVC) fibers, PVC-free fibers made of polyester, polyamide, polyimide, polyacrylic, polypropylene, polyethylene, polyurethane, polystyrene, polyaramid (e.g., Kevlar®) polytetrafluoroethylene (Teflon®) (both trademarks of E.I. du Pont de Nemours and Company, Delaware), fiberglass, polytrimethylene, polycarbonate, polyethylene terephthalate, polyester terephthalate, polybutylene terephthalate, or a combination thereof. In an example, natural and synthetic fibers may be combined at ratios of 1:1, 1:2, 1:3, 1:4, 1:5, 1:6, 1:7, 1:8, 1:9, 1:10, 1:11, 1:12, 1:13, 1:14, 1:15, 1:16, 1:17, 1:18, 1:19, 1:20, or vice versa. In some examples, the fiber can be a modified fiber from the above-listed polymers. The term “modified fiber” refers to one or both of the polymeric fiber and the fabric as a whole having undergone a chemical or physical process such as, but not limited to, copolymerization with monomers of other polymers, a chemical grafting reaction to contact a chemical functional group with one or both the polymeric fiber and a surface of the fabric, a plasma treatment, a solvent treatment, acid etching, or a biological treatment, an enzyme treatment, or antimicrobial treatment to prevent biological degradation.

In addition, the textile fabric can contain additives, such as a colorant (e.g., pigments, dyes, and tints), an antistatic agent, a brightening agent, a nucleating agent, an antioxidant, a UV stabilizer, a filler, and/or a lubricant, for example.

It is to be understood that the terms “textile fabric” or “fabric substrate” do not include materials commonly known as any kind of paper (even though paper can include multiple types of natural and synthetic fibers or mixtures of both types of fibers). Fabric substrates can include textiles in filament form, textiles in the form of fabric material, or textiles in the form of fabric that has been crafted into finished articles (e.g., clothing, blankets, tablecloths, napkins, towels, bedding material, curtains, carpet, handbags, shoes, banners, signs, flags, etc.). In some examples, the fabric substrate can have a woven, knitted, non-woven, or tufted fabric structure. In one example, the fabric substrate can be a woven fabric where warp yarns and weft yarns can be mutually positioned at an angle of about 90°. This woven fabric can include fabric with a plain weave structure, fabric with twill weave structure where the twill weave produces diagonal lines on a face of the fabric, or a satin weave. In another example, the fabric substrate can be a knitted fabric with a loop structure. The loop structure can be a warp-knit fabric, a weft-knit fabric, or a combination thereof. A warp-knit fabric refers to every loop in a fabric structure that can be formed from a separate yarn mainly introduced in a longitudinal fabric direction. A weft-knit fabric refers to loops of one row of fabric that can be formed from the same yarn. In a further example, the fabric substrate can be a non-woven fabric. For example, the non-woven fabric can be a flexible fabric that can include a plurality of fibers or filaments that are one or both bonded together and interlocked together by a chemical treatment process (e.g., a solvent treatment), a mechanical treatment process (e.g., embossing), a thermal treatment process, or a combination of multiple processes.

In one example, the textile fabric can have a basis weight ranging from 10 gsm to 500 gsm. In another example, the textile fabric can have a basis weight ranging from 50 gsm to 400 gsm. In other examples, the textile fabric can have a basis weight ranging from 100 gsm to 300 gsm, from 75 gsm to 250 gsm, from 125 gsm to 300 gsm, or from 150 gsm to 350 gsm.

Kits

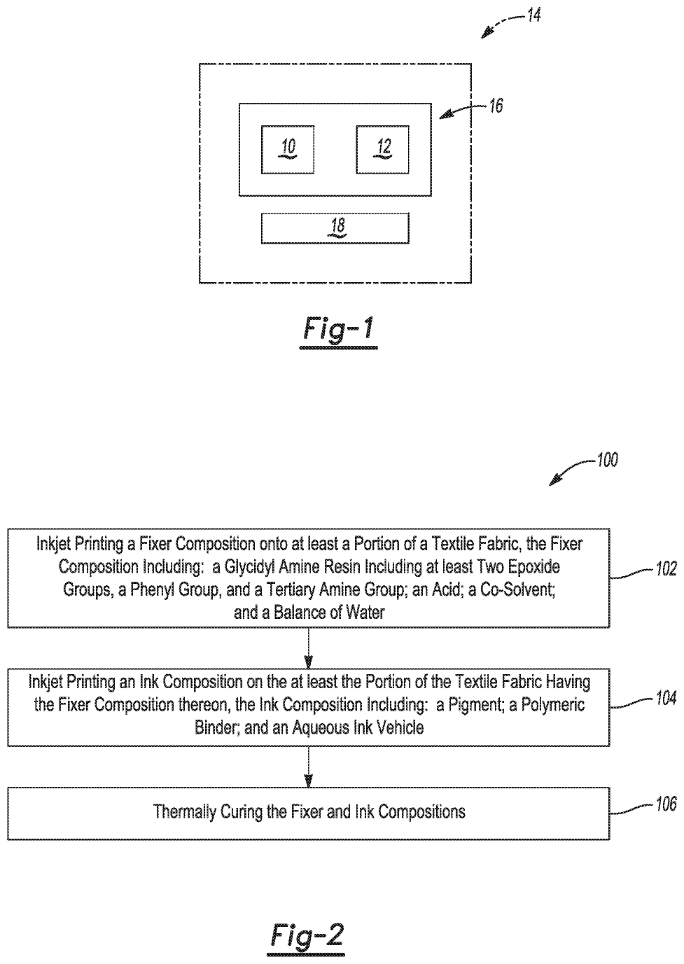

The fixer and ink compositions disclosed herein may be part of a printing kit 14, which is shown schematically in FIG. 1.

In some examples, the printing kit 14 includes i) a fixer composition 10, which includes: a glycidyl amine resin including at least two epoxide groups, a phenyl group, and a tertiary amine group; an acid; a co-solvent; and a balance of water; and ii) an ink composition 12, which includes: a pigment, a polymeric binder, and an aqueous ink vehicle. When the printing kit includes the fixer composition 10 and ink composition 12 (e.g., without a textile fabric 18), the printing kit 14 may be considered to be a fluid kit 16.

It is to be understood that any example of the fixer composition 10 and the ink composition 12 disclosed herein may be used in the printing kit 14 or fluid kit 16. In some examples, the fixer composition 10 has a pH of about 8.5 or less, and the ink composition 12 has a pH of greater than 7. In some examples, the printing kit 14 or fluid kit 16 includes compositions 10, 12 that are formulated for thermal inkjet printing. In one particular example of the printing kit 14, the glycidyl amine resin (in the fixer composition 10) is selected from the group consisting of tetraglycidyl meta-xylenediamine, N,N′-tetraglycidyl diaminodiphenylmethane, triglycidylether meta-aminophenol, triglycidylether para-aminophenol, and combinations thereof; and the acid (in the fixer composition 10) is selected from the group consisting of CH₃COOH (acetic acid), HCO₂H (formic acid), alkyl-CO₂H, HCl (hydrochloric acid), HNO₃ (nitric acid), H₂SO₄ (sulfuric acid), and alkyl-SO₃H. In this example, a molar ratio of the tertiary amine group(s) of the glycidyl amine resin to the acid ranges from 1:0.5 to about 1:2.

In any example of the printing kit 14 or fluid kit 16, the fixer composition 10 and the ink composition 12 may be maintained in separate containers (e.g., respective reservoirs/fluid supplies of respective inkjet cartridges) or separate compartments (e.g., respective reservoirs/fluid supplies) in a single container (e.g., inkjet cartridge).

In some examples, the printing kit 14 further includes a textile fabric 18 selected from the group consisting of polyester fabrics, polyester blend fabrics, cotton fabrics, cotton blend fabrics, nylon fabrics, nylon blend fabrics, silk fabrics, silk blend fabrics, wool fabrics, wool blend fabrics, and combinations thereof. It is to be understood that any example of the textile fabric 18 may be used in the examples of the printing kit 14.

Printing Method and System

FIG. 2 depicts an example of the printing method 100. As shown in FIG. 2, an example of the printing method 100 comprises: inkjet printing a fixer composition 10 onto at least a portion of a textile fabric 18, the fixer composition 10 including: a glycidyl amine resin including at least two epoxide groups, a phenyl group, and a tertiary amine group; an acid; a co-solvent; and a balance of water (as shown at reference numeral 102); inkjet printing an ink composition 12 on the at least the portion of the textile fabric 18 having the fixer composition 10 thereon, the ink composition 12 including: a pigment; a polymeric binder; and an aqueous ink vehicle (as shown at reference numeral 104); and thermally curing the fixer and ink compositions 10, 12 (as shown at reference numeral 106).

It is to be understood that any example of the fixer composition 10, the ink composition 12, and the textile fabric 18 may be used in the examples of the method 100.

As shown in reference numerals 102 and 104 in FIG. 2, the method 100 includes inkjet printing the fixer composition 10 onto at least a portion of the textile fabric 18, and then inkjet printing the ink composition 12 onto the at least the portion of the textile fabric 18 having the fixer composition 10 thereon.

In an example of the method 100, the fixer composition 10 and the ink composition 12 are applied in a single pass. As an example of single pass printing, the cartridges of an inkjet printer respectively deposit each of the compositions during the same pass of the cartridges across the textile fabric 18. In other words, the fixer composition 10 and the ink composition 12 are applied sequentially one immediately after the other as the applicators (e.g., cartridges, pens, printheads, etc.) pass over the textile fabric 18. In other examples, the fixer composition 10 and the ink composition 12 may each be applied in separate passes.

In some examples of the method 100, the ink composition 12 is printed onto the printed fixer composition 10 while the fixer composition 10 is wet. Wet on wet printing may be desirable because less fixer composition 10 may be applied during this process (as compared to when the fixer composition 10 is dried prior to ink application), and because the printing workflow may be simplified without the additional drying of the fixer. In an example of wet on wet printing, the ink composition 12 is printed onto the printed fixer composition 10 within a period of time ranging from about 0.01 second to about 30 seconds after the fixer composition 10 is printed. In further examples, ink composition 12 is printed onto the previously applied fixer composition 10 within a period of time ranging from about 0.1 second to about 20 seconds; or from about 0.2 second to about 10 seconds; or from about 0.2 second to about 5 seconds after the previously applied fixer composition 10 is printed. In an example, wet on wet printing may be accomplished in a single pass.

In another example of the method 100, drying takes place after the application of one composition and before the application of the next composition. As such, the printed fixer composition 10 may be dried on the textile fabric 18 before the ink composition 10 is applied. It is to be understood that in this example, drying of the fixer composition 10 may be accomplished in any suitable manner, e.g., air dried (e.g., at a temperature ranging from about 20° C. to about 80° C. for 30 seconds to 5 minutes), exposure to electromagnetic radiation (e.g., infra-red (IR) radiation for 5 seconds) to generate heat, and/or the like. When drying is performed, the compositions 10, 12 may be applied in separate passes to allow time for the drying to take place.

In one example of the method 100, both the fixer composition 10 and the ink composition 12 are inkjet printed with a thermal inkjet printer. In another example, one or both of the fixer composition 10 and the ink composition 12 are inkjet printed with a piezoelectric inkjet printer. In still another example, the fixer composition 10 may be applied via an analog method and the ink composition 12 may be applied via a digital method. As an example, the fixer composition 10 may be applied via spray coating, roll on method, or padding. These techniques will apply the fixer composition 10 to the entire substrate. The ink composition can then be digitally printed using thermal or piezoelectric printing at desirable areas.

As mentioned herein, the method 100 may further include curing the fixer and ink compositions 10, 12. In an example of the method 100, curing involves heating to a temperature ranging from about 80° C. to about 200° C. for period of time ranging from about 5 seconds to 15 minutes. In some examples, a heating device can be used to apply heat to the textile fabric 18 to cure the ink composition 12, e.g., causing the crosslinking reaction between components of the fixer composition 10 and components of the ink composition 12 and/or of the textile fabric 18 to occur or accelerate. Heat can be applied using forced hot air, a heating lamp, an oven, or the like. Curing the ink composition 12 contacted with the fixer composition 10 on the textile fabric 18 can occur at a temperature ranging from 80° C. to 200° C. for a time ranging from about 5 seconds to about 10 minutes, or from about 100° C. to about 180° C. for from about 30 seconds to about 4 minutes. In an example, curing is achieved by heating the printed compositions 10, 12 to a temperature of 150° C. for about 3 minutes.

In an example of the method 100, a ratio of printed fixer composition 10 to printed ink composition 12 ranges from about 1:15 by volume to about 1:0.2 by volume.

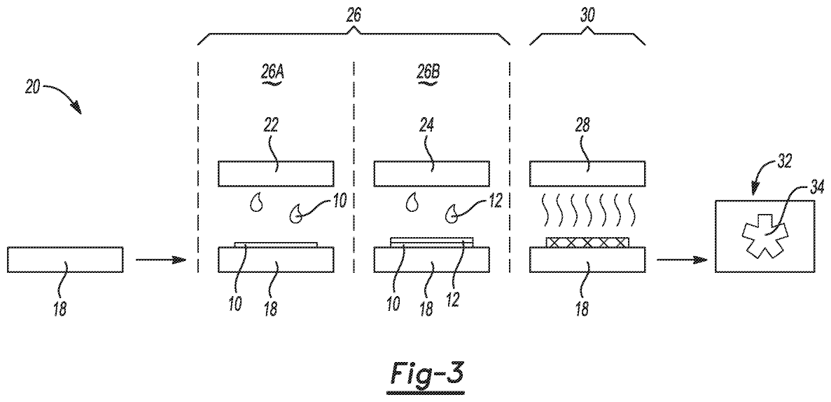

Referring now to FIG. 3, a schematic diagram of a printing system 20 including inkjet printheads 22, 24 in a printing zone 26 of the printing system 20 and a dryer 28 positioned in a fixation zone 30 of the printing system 20.

In one example, a textile fabric 18 may be transported through the printing system 20 along the path shown by the arrows such that the textile fabric 18 is first fed to the printing zone 26. In the printing zone 26, the textile fabric 18 is first transported through a fixing or pre-treatment zone 26A where an example of the fixer composition 10 is inkjet printed directly onto the textile fabric 18 by the inkjet printhead 22 (for example, from thermal-inkjet printhead). This forms pre-treated area(s) on the textile fabric 18. The fixer composition 10 disposed on the textile fabric 18 may be heated in the printing zone 26 (for example, the air temperature in the printing zone 26 may range from about 10° C. to about 90° C.) such that water may be at least partially evaporated from the printed fixer composition 10. Alternatively, the fixer composition 10 disposed on the textile fabric 18 may remain wet. The textile fabric 18 is then transported through an ink zone 26B where an example of the ink composition 12 is inkjet printed directly onto the area(s) of the textile fabric 18 that have the fixer composition 10 thereon. While shown as separately layers in FIG. 3, the printed fixer composition 10 and ink composition 12 may intermingle and absorb in and between the fibers of the textile substrate 18. The ink composition 12 may be inkjet printed, e.g., from a piezo- or thermal-inkjet printhead. The printed ink composition 12 may be heated in the printing zone 26 (for example, the air temperature in the printing zone 14 may range from about 10° C. to about 90° C.) such that water may be at least partially evaporated from the printed ink.

Rather than specific zones 26A, 26B where each of the compositions 10, 12 is applied, it is to be understood that the printing system 20 may include one printing zone 26 where inkjet cartridges are moved across the textile fabric 18 to deposit the compositions 10, 12 in a single pass or in multiple passes.

If desirable, the pre-treatment zone 26A may be a station for analog application of the fixer composition 10 and the ink zone 26B may be an inkjet print zone for digital application of the ink composition 12.

The textile fabric 18 (having the fixer and ink compositions 10, 12 printed thereon) may then be transported to the fixation zone 30 where the compositions/layers are heated to crosslink the epoxide groups in the fixer composition 10 with reactive groups in the textile fabric 18 and/or in the ink composition 12, and to crash and fix the pigment in the ink composition. The heat is sufficient to initiate crosslinking or other interactions that bind the pigment onto the textile fabric 18. The heat to initiate fixation (thermal curing) may range from about 80° C. to 200° C. as described above. This process forms the printed article 32 including the image 34 formed on the textile fabric 18.

To further illustrate the present disclosure, an example is given herein. It is to be understood that this example is provided for illustrative purposes and is not to be construed as limiting the scope of the present disclosure.

### Example

Two examples of the fixer composition disclosed herein (ex. fixer 1 and ex. fixer 2) were prepared. The example glycidyl amine resin included in the example fixers was ERISYS® GA-240 (tetraglycidyl meta-xylenediamine available from CVC Thermoset Specialties). A comparative example fixer composition was also prepared with poly(ethylene glycol) diglycidyl ether. This resin does not include any amine groups or any phenyl group. The general formulation of each of the example fixers and the comparative example fixer is shown in Table 1, with the wt % active of each component that was used. Some of the properties of the fixers are also shown in Table 1.

TABLE 1

| | Specific | Ex. | Ex. | Comp. Ex. |
|---|---|---|---|---|
| Ingredient | Component | Fixer 1 | Fixer 2 | Fixer 3 |
| Resin | tetraglycidyl meta- | 3 | 6 | — |
| | xylenediamine | | | |
| | poly(ethylene glycol) | — | — | 6 |
| | diglycidyl ether | | | |
| Co-solvent | 2-Pyrrolidone | 4 | 4 | 4 |
| Acid | Acetic acid, glacial | 0.86 | 1.72 | — |
| Surfactant | SURFYNOL ® 440 | 0.3 | 0.3 | 0.3 |
| Water | Deionized water | Bal. | Bal. | Bal. |
| Properties | pH | 6.85 | 7.78 | 7.74 |
| | Viscosity (cP) | 1.0 | 1.2 | 1.2 |

Four examples of the ink composition disclosed herein (black ink, cyan ink, magenta ink, and yellow ink) were also prepared. Each example ink composition had the same general formulation except for the pigment dispersion used. The general formulation of each of the example ink compositions is shown in Table 2, with the wt % active of each component that was used (e.g., wt % active black pigment or wt % active cyan pigment). A 5 wt % potassium hydroxide aqueous solution was added to each of the inks until a pH of about 8.5 was achieved.

TABLE 2

| | | Black | Cyan | Magenta | Yellow |
|---|---|---|---|---|---|
| | | Ink | Ink | Ink | Ink |
| | Specific | (wt % | (wt % | (wt % | (wt % |
| Ingredient | Component | active) | active) | active) | active) |
| Pigment | Black pigment | 3 | — | — | — |
| | dispersion | | | | |
| dispersion | Cyan pigment | — | 2.5 | — | — |
| | dispersion | | | | |
| | Magenta | — | — | 3 | — |
| | pigment | | | | |
| | dispersion | | | | |
| | Yellow pigment | — | — | — | 3 |
| | dispersion | | | | |
| Binder | IMPRANIL ® | 6 | 6 | 6 | 6 |
| | DLN-SD | | | | |
| Co-solvent | Glycerol | 8 | 8 | 8 | 8 |
| Anti-decel | LIPONIC ® | 1 | 1 | 1 | 1 |
| agent | EG-1 | | | | |
| Anti-kogation | CRODAFOS ™ | 0.5 | 0.5 | 0.5 | 0.5 |
| agent | N-3A | | | | |
| Surfactant | SURFYNOL ® | 0.3 | 0.3 | 0.3 | 0.3 |
| | 440 | | | | |
| Antimicrobial | ACTICIDE ® | 0.044 | 0.044 | 0.044 | 0.044 |
| agent | B20 | | | | |
| Water | Deionized water | Bal. | Bal. | Bal. | Bal. |

Control prints, example prints, and comparative prints were generated on untreated cotton and woven cotton sheeting. Table 3 identifies the various prints that were generated, including the ink and fixer used, the ink loading, and the fixer loading.

The control prints (A-D) were generated using the inks (and no fixer composition).

Some example prints (F-H and M-P) were generated using Ex. Fixer 1 and each of the example inks. Other example prints (I-L and Q-T) were generated using Ex. Fixer 2 and each of the example inks.

Comparative prints (U-X) were generated using Comp. Ex. Fixer 3 and the example inks.

All inks and fixers were thermal inkjet printed with a 12 ng drop weight printhead and a testbed inkjet printer. For the control prints, the inks were printed on the respective textile fabrics. To generate the example and comparative prints, the respective fixer was printed on the respective textile fabric, and then in the same printing pass, the ink was printed. All prints were cured at 150° C. for 3 minutes.

TABLE 3

| | untreated cotton or woven cotton sheeting | | | |
|---|---|---|---|---|
| | | Fixer | | Ink |
| | | Loading | | Loading |
| Print ID | Fixer ID | (gsm*) | Ink ID | (gsm*) |
| Control A | None | N/A | Black | 20 |
| Control B | None | N/A | Cyan | 20 |
| Control C | None | N/A | Magenta | 20 |
| Control D | None | N/A | Yellow | 20 |
| Ex. Print E | Ex. Fixer 1 | 10 | Black | 20 |
| Ex. Print F | Ex. Fixer 1 | 10 | Cyan | 20 |
| Ex. Print G | Ex. Fixer 1 | 10 | Magenta | 20 |
| Ex. Print H | Ex. Fixer 1 | 10 | Yellow | 20 |
| Ex. Print I | Ex. Fixer 2 | 10 | Black | 20 |
| Ex. Print J | Ex. Fixer 2 | 10 | Cyan | 20 |
| Ex. Print K | Ex. Fixer 2 | 10 | Magenta | 20 |
| Ex. Print L | Ex. Fixer 2 | 10 | Yellow | 20 |
| Ex. Print M | Ex. Fixer 1 | 20 | Black | 20 |
| Ex. Print N | Ex. Fixer 1 | 20 | Cyan | 20 |
| Ex. Print O | Ex. Fixer 1 | 20 | Magenta | 20 |
| Ex. Print P | Ex. Fixer 1 | 20 | Yellow | 20 |
| Ex. Print Q | Ex. Fixer 2 | 20 | Black | 20 |
| Ex. Print R | Ex. Fixer 2 | 20 | Cyan | 20 |
| Ex. Print S | Ex. Fixer 2 | 20 | Magenta | 20 |
| Ex. Print T | Ex. Fixer 2 | 20 | Yellow | 20 |
| Comp. Ex. Print U | Comp. Ex. Fixer 3 | 10 | Black | 20 |
| Comp. Ex. Print V | Comp. Ex. Fixer 3 | 10 | Cyan | 20 |
| Comp. Ex. Print W | Comp. Ex. Fixer 3 | 10 | Magenta | 20 |
| Comp. Ex. Print X | Comp. Ex. Fixer 3 | 10 | Yellow | 20 |

*gsm = grams per square meter

Optical Density and Washfastness

Optical density indicates the darkness of a print, as it measured absorbance. The initial optical density (initial GD) of each print was measured. Then, each print was washed 5 times in a Whirlpool Washer (Model WTW5000DW) with warm water (at about 40° C.) and detergent. Each print was allowed to air dry between each wash. Then, the optical density (OD after 5 washes) of each print was measured, and the percent change in optical density (% Δ OD) was calculated for each print. The percent change in optical density is indicative of the washfastness, and thus the durability of the print. For black, cyan, and magenta inks, a percent change in optical density of less than 10% after 5 washes is a good optical density percent change for a print on untreated cotton or woven cotton sheeting. For yellow ink, a percent change in optical density of 12.5% or less after 5 washes is a good optical density percent change for a print on untreated cotton or woven cotton sheeting.

The initial optical density (initial OD), the optical density after 5 washes (OD after 5 washes), and the percent change in optical density (% Δ in OD) of each print are shown in Table 4.

TABLE 4

| | untreated cotton | | | woven cotton sheeting | | |
|---|---|---|---|---|---|---|
| | Initial | OD after | %Δ in | Initial | OD after | %Δ in |
| Print ID | OD | 5 washes | OD | OD | 5 washes | OD |
| Control A | 1.108 | 0.918 | −17.1 | 1.033 | 0.874 | −15.4 |
| Control B | 1.062 | 0.914 | −14.0 | 0.988 | 0.842 | −14.8 |
| Control C | 1.008 | 0.880 | −12.7 | 0.907 | 0.772 | −14.8 |
| Control D | 1.011 | 0.795 | −21.4 | 0.928 | 0.723 | −22.1 |
| Ex. Print E | 1.093 | 1.000 | −8.5 | 1.088 | 1.004 | −7.7 |
| Ex. Print F | 1.016 | 0.965 | −5.0 | 1.060 | 0.978 | −7.7 |
| Ex. Print G | 0.986 | 0.937 | −5.0 | 0.999 | 0.939 | −6.1 |
| Ex. Print H | 1.017 | 0.890 | −12.5 | 1.032 | 0.921 | −10.8 |
| Ex. Print 1 | 1.116 | 1.040 | −6.8 | 1.127 | 1.043 | −7.5 |
| Ex. Print J | 1.051 | 1.001 | −4.8 | 1.067 | 1.002 | −6.1 |
| Ex. Print K | 1.008 | 0.973 | −3.5 | 1.005 | 0.954 | −5.1 |
| Ex. Print L | 1.053 | 0.928 | −11.9 | 1.041 | 0.932 | −10.5 |
| Ex. Print M | 1.127 | 1.065 | −5.5 | 1.194 | 1.111 | −7.0 |
| Ex. Print N | 1.090 | 1.039 | −4.7 | 1.150 | 1.099 | −4.5 |
| Ex. Print O | 1.023 | 0.955 | −6.7 | 1.050 | 1.002 | −4.6 |
| Ex. Print P | 1.064 | 0.934 | −12.2 | 1.116 | 1.011 | −9.4 |
| Ex. Print Q | 1.140 | 1.060 | −7.0 | 1.180 | 1.120 | −5.1 |
| Ex. Print R | 1.059 | 1.025 | −3.2 | 1.145 | 1.122 | −2.1 |
| Ex. Print S | 1.029 | 0.987 | −4.1 | 1.057 | 1.026 | −2.9 |
| Ex. Print T | 1.075 | 0.970 | −9.7 | 1.122 | 1.042 | −7.2 |
| Comp. Ex. Print U | 1.039 | 0.853 | −17.9 | 1.066 | 0.876 | −17.8 |
| Comp. Ex. Print V | 1.009 | 0.856 | −15.2 | 1.012 | 0.838 | −17.2 |
| Comp. Ex. Print W | 0.910 | 0.802 | −11.8 | 0.908 | 0.774 | −14.8 |
| Comp. Ex. Print X | 0.924 | 0.754 | −18.5 | 0.959 | 0.760 | −20.7 |

As shown in Table 4, the example prints of any given color exhibited a smaller % change in optical density after washing than the control prints or the comparative prints of the same color. Overall, the optical density for the example prints (E-T) was generally improved relative to the control prints A-D and the comparative prints U-X (when comparing the same color print). For the example prints, the % change in optical density results were relatively consistent on the respective textile fabrics, regardless of the amount of the glycidyl amine resin or the loading of fixer applied.

Table 4 also shows that the comparative fixer did not improve the initial optical density or the optical density after 5 washes of the prints (comp. prints U-X) generated on either textile fabric when compared with the control prints that had to fixer composition.

Washfastness (ΔE)

The durability of a print on a fabric may be assessed by its ability to retain color after being exposed to washing. This is also known as washfastness. Each print was also tested for washfastness.

Washfastness can be measured in terms of ΔE. The term “ΔE,” as used herein, refers to the change in the L*a*b* values of a color (e.g., cyan, magenta, yellow, black, red, green, blue, white) after washing. AE can be calculated by different equations, such as the CIEDE1976 color-difference formula (ΔE₇₆), the CIEDE2000 color-difference formula (ΔE₀₀), or using the color difference method of the Color Measurement Committee (ΔE_{CMC}). A smaller ΔE value indicates better washfastness.

The L*a*b* values of a color (e.g., cyan, magenta, yellow, black, red, green, blue, white) before and after the 5 washes were measured. L* is lightness, a* is the color channel for color opponents green-red, and b* is the color channel for color opponents blue-yellow. The color change was then calculated using the CIEDE1976 color-difference formula, the CIEDE2000 color-difference formula, and the color difference method of the Color Measurement Committee (ΔE_{CMC}).

The color change ΔE₇₆ was calculated by:

ΔE₇₆=[(ΔL*)²+(Δa*)²(Δb*)²]^{0.5}

The CIEDE2000 color-difference formula is based on the CIELAB color space. Given a pair of color values in CIELAB space L*₁, a*₁, b*₁ and L*₂, a*₂, b*₂, the CIEDE2000 color difference between them is as follows:

ΔE₀₀(L₁*,a₁*,b₁*;L₂*;L₂*,a₂*,b₂*)=ΔE₀₀¹²=ΔE₀₀ (1)

It is noted that ΔE₀₀ is the commonly accepted notation for CIEDE2000.

Given two CIELAB color values {Lᵢ*, aᵢ*, bᵢ*}ᵢ₌₁² and parametric weighting factors k_{L}, k_{C}, k_{H}, the process of computation of the color difference is summarized in the following equations, grouped as three main parts.

1. Calculate C′ᵢ, h′ᵢ:

$${C}_{i , ab}^{*} = \sqrt{( {( {a}_{i}^{*} )}^{2} + {( {b}_{i}^{*} )}^{2} )} , i = 1 , 2 \qquad ( 2 )$$

$${\overline{C}}_{a b}^{*} = \frac{{c}_{1 , ab}^{*} + {c}_{2 , ab}^{*}}{2} \qquad ( 3 )$$

$$G = 0. 5 ( 1 - \sqrt{( \frac{{\overline{C}}_{a b}^{7}}{{\overline{C}}_{a b}^{* 7} + 2 {5}^{7}} )} ) \qquad ( 4 )$$

$${a}_{i}^{′} = ( 1 + G ) {a}_{i}^{*} , i = 1 , 2 \qquad ( 5 )$$

$${c}_{i}^{′} = \sqrt{( {( {a}_{i}^{′} )}^{2} + {( {b}_{i}^{′} )}^{2} )} , i = 1 , 2 \qquad ( 6 )$$

$${h}_{i}^{′} = \{ \begin{matrix}0 & {b}_{i}^{*} = {a}_{i}^{′} = 0 \\ {tan}^{- 1} ( {b}_{i}^{*} , {a}_{i}^{′} ) & otherwise\end{matrix} , i = 1 , 2 \qquad ( 7 )$$

2. Calculate ΔL′, ΔC′, ΔH′:

$$Δ {L}^{′} = {L}_{2}^{*} - {L}_{1}^{*} \qquad ( 8 )$$

$$Δ {C}^{′} = {C}_{2}^{*} - {C}_{1}^{*} \qquad ( 9 )$$

$$Δ {h}^{′} = \{ \begin{matrix}0 & {C}_{1}^{′} {C}_{2}^{′} = 0 \\ {h}_{2}^{′} - {h}_{1}^{′} & {C}_{1}^{′} {C}_{2}^{′} \neq 0 ; \vert {h}_{2}^{′} - {h}_{1}^{′} \vert \leq 18 {0}^{∘} \\ ( {h}_{2}^{′} - {h}_{i}^{′} ) - 360 & {C}_{1}^{′} {C}_{2}^{′} \neq 0 ; ( {h}_{2}^{′} - {h}_{1}^{′} ) > 18 {0}^{∘} \\ ( {h}_{2}^{′} - {h}_{i}^{′} ) + 360 & {C}_{1}^{′} {C}_{2}^{′} \neq 0 ; ( {h}_{2}^{′} - {h}_{1}^{′} ) < - 18 {0}^{∘}\end{matrix} \} \qquad ( 10 )$$

$$Δ {H}^{′} = 2 \sqrt{{C}_{1}^{′} {C}_{2}^{′}} sin ( \frac{Δ {h}^{′}}{2} ) \qquad ( 11 )$$

3. Calculate CIEDE2000 color-difference ΔE₀₀:

$${\overline{L}}^{′} = ( {L}_{1}^{*} + {L}_{2}^{*} ) / 2 \qquad ( 12 )$$

$${\overline{C}}^{′} = ( {C}_{1}^{′} + {C}_{2}^{′} ) / 2 \qquad ( 13 )$$

$${\overline{h}}^{′} = \{ \begin{matrix}\frac{{h}_{1}^{′} + {h}_{2}^{′}}{2} \\ \frac{{h}_{1}^{′} + {h}_{2}^{′} + 360 °}{2} \\ \frac{{h}_{1}^{′} + {h}_{2}^{′} - 360 °}{2} \\ ( {h}_{1}^{′} + {h}_{2}^{′} )\end{matrix} \begin{matrix}\vert {h}_{1}^{′} - {h}_{2}^{′} \vert \leq 180 ° ; {C}_{1}^{′} {C}_{2}^{′} \neq 0 \\ \vert {h}_{1}^{′} - {h}_{2}^{′} \vert > 180 ° ; ( {h}_{1}^{′} - {h}_{2}^{′} ) < 360 ° ; {C}_{1}^{′} {C}_{2}^{′} \neq 0 \\ \vert {h}_{1}^{′} - {h}_{2}^{′} \vert > 180 ° ; ( {h}_{1}^{′} - {h}_{2}^{′} ) \geq 360 ° ; {C}_{1}^{′} {C}_{2}^{′} \neq 0 \\ {C}_{1}^{′} {C}_{2}^{′} = 0\end{matrix} \qquad ( 14 )$$

$$T = 1 - 0.17 cos ( {\overline{h}}^{′} - {30}^{∘} ) + 0.24 cos ( 2 {\overline{h}}^{′} ) + 0.32 cos ( 3 {\overline{h}}^{′} + {6}^{∘} ) - 0.20 cos ( 4 {\overline{h}}^{′} - {63}^{∘} ) \qquad ( 15 )$$

$$Δθ = 30 exp \{ - {[ \frac{{\overline{h}}^{′} - 27 {5}^{∘}}{25} ]}^{2} \} \qquad ( 16 )$$

$${R}_{c} = 2 \sqrt{( \frac{{\overline{C}}^{′7}}{{\overline{C}}^{′7} + 2 {5}^{7}} )} \qquad ( 17 )$$

$${S}_{L} = 1 + \frac{0.015 {( {\overline{L}}^{′} - 50 )}^{2}}{\sqrt{( 20 + {( {\overline{L}}^{′} - 50 )}^{2} )}} \qquad ( 18 )$$

$${S}_{C} = 1 + 0.045 {\overline{C}}^{′} \qquad ( 19 )$$

$${S}_{H} = 1 + 0.015 {\overline{C}}^{′} T \qquad ( 20 )$$

$${R}_{T} = - sin ( 2 Δ θ ) {R}_{C} \qquad ( 21 )$$

$$Δ {E}_{00}^{12} = Δ {E}_{00} ( {L}_{1}^{*} , {a}_{1}^{*} , {b}_{1}^{*} ; {L}_{2}^{*} ; {L}_{2}^{*} , {a}_{2}^{*} , {b}_{2}^{*} ) = \sqrt{( {( \frac{Δ {L}^{′}}{{k}_{L} {S}_{L}} )}^{2} + ( {( \frac{Δ {C}^{′}}{{k}_{C} {S}_{C}} )}^{2} + {( \frac{Δ {H}^{′}}{{k}_{H} {S}_{H}} )}^{2} + {R}_{T} ( \frac{Δ {C}^{′}}{{k}_{C} {S}_{C}} ) ( \frac{Δ {H}^{′}}{{k}_{H} {S}_{H}} ) )} \qquad ( 22 )$$

The color difference method of the Color Measurement Committee (the CMC) is a model using two parameters l and c, typically expressed as CMC(l:c). Commonly used values for acceptability are CMC(2:1), and these are the values set forth herein. The color difference ΔE_{CMC(2:1)} between the print (L₂, a₂, b₂) and a reference color (L₁, a₁, b₁) was calculated by:

$$Δ {E}_{C M C ( 2 : 1 )} = \sqrt{{( \frac{Δ L}{l {S}_{L}} )}^{2} + {( \frac{Δ C}{c {S}_{c}} )}^{2} + {( \frac{Δ H}{{S}_{H}} )}^{2}} \qquad ( 23 )$$

$$where :$$

$$Δ C = {C}_{1} - {C}_{2} \qquad ( 24 )$$

$${C}_{1} = \sqrt{{{a}_{1}}^{2} + {{b}_{1}}^{2}} \qquad ( 25 )$$

$${C}_{2} = \sqrt{{{a}_{2}}^{2} + {{b}_{2}}^{2}} \qquad ( 26 )$$

$$Δ H = \sqrt{Δ {a}^{2} + Δ {b}^{2} - Δ {C}^{2}} \qquad ( 27 )$$

$$Δ L = {L}_{1} - {L}_{2} \qquad ( 28 )$$

$$Δ a = {a}_{1} - {a}_{2} \qquad ( 29 )$$

$$Δ b = {b}_{1} - {b}_{2} \qquad ( 30 )$$

$${S}_{L} = \{ \begin{matrix}0.511 \\ \frac{0.04 0975 {L}_{1}}{1 + 0.01765 {L}_{1}}\end{matrix} \begin{matrix}if {L}_{1} < 16 \\ if {L}_{1} \geq 16\end{matrix} \qquad ( 31 )$$

$${S}_{C} = \frac{0.0638 {C}_{1}}{1 + 0.0131 {C}_{1}} + 0 \text{.638} \qquad ( 32 )$$

$${S}_{H} = {S}_{C} ( F T + 1 - F ) \qquad ( 33 )$$

$$T = \{ \begin{matrix}0.56 + \vert 0.2 cos ( {H}_{1} + 16 {8}^{∘} ) \vert \\ 0.33 + \vert 0.4 cos ( {H}_{1} + 3 {5}^{∘} ) \vert\end{matrix} \begin{matrix}if 164 ° \leq {H}_{1} \leq 345 ° \\ otherwise\end{matrix} \qquad ( 34 )$$

$$F = \sqrt{\frac{{c}_{1}^{4}}{{C}_{1}^{4} + 1900}} \qquad ( 35 )$$

$$H = arctan ( \frac{{b}_{1}}{{a}_{1}} ) \qquad ( 36 )$$

$${H}_{1} = \{ \begin{matrix}H & if H \geq 0 \\ H + 360 ° & otherwise\end{matrix} \qquad ( 37 )$$

The results of the ΔE₇₆ calculations, the ΔE₀₀ calculations, and the ΔE_{CMC(2:1)} calculations for each print are shown in Table 5.

TABLE 5

| | untreated cotton | | | woven cotton sheeting | | |
|---|---|---|---|---|---|---|
| Print ID | ΔE₇₆ | ΔE₀₀ | ΔE_{CMC(2:1)} | ΔE₇₆ | ΔE₀₀ | ΔE_{CMC(2:1)} |
| Control A | 9.2 | 8.0 | 8.4 | 9.1 | 8.1 | 8.1 |
| Control B | 5.9 | 4.3 | 3.3 | 5.7 | 4.2 | 3.0 |
| Control C | 7.3 | 3.7 | 3.2 | 7.1 | 3.5 | 3.0 |
| Control D | 12.0 | 2.7 | 3.8 | 12.5 | 3.0 | 4.0 |
| Ex. Print E | 5.4 | 4.8 | 5.8 | 4.8 | 4.3 | 5.4 |
| Ex. Print F | 4.2 | 2.2 | 2.4 | 4.2 | 2.8 | 2.3 |
| Ex. Print G | 4.9 | 2.3 | 2.4 | 4.2 | 1.9 | 2.0 |
| Ex. Print H | 6.7 | 1.5 | 2.1 | 5.9 | 1.3 | 1.9 |
| Ex. Print I | 4.9 | 4.4 | 5.5 | 5.0 | 4.4 | 5.3 |
| Ex. Print J | 4.8 | 2.3 | 2.7 | 4.3 | 2.2 | 2.4 |
| Ex. Print K | 4.4 | 2.0 | 2.2 | 3.8 | 1.7 | 1.9 |
| Ex. Print L | 5.7 | 1.3 | 1.8 | 5.1 | 1.2 | 1.6 |
| Ex. Print M | 4.8 | 4.3 | 5.2 | 4.4 | 3.9 | 5.1 |
| Ex. Print N | 4.6 | 2.0 | 2.6 | 4.2 | 2.0 | 2.3 |
| Ex. Print O | 4.6 | 2.1 | 2.3 | 4.2 | 2.0 | 2.1 |
| Ex. Print P | 7.0 | 1.6 | 2.2 | 4.8 | 1.1 | 1.5 |
| Ex. Print Q | 4.5 | 4.1 | 5.2 | 3.8 | 3.5 | 4.5 |
| Ex. Print R | 5.6 | 2.8 | 3.2 | 4.7 | 2.2 | 2.6 |
| Ex. Print S | 4.9 | 2.2 | 2.5 | 4.1 | 1.8 | 2.0 |
| Ex. Print T | 4.2 | 1.1 | 1.4 | 3.5 | 0.9 | 1.1 |
| Comp. Ex. Print U | 10.4 | 9.3 | 8.7 | 9.3 | 8.2 | 7.7 |
| Comp. Ex. Print V | 6.3 | 4.6 | 3.2 | 7.0 | 5.2 | 3.4 |
| Comp. Ex. Print W | 5.9 | 2.8 | 2.6 | 7.5 | 3.6 | 3.1 |
| Comp. Ex. Print X | 10.9 | 2.6 | 3.5 | 11.6 | 2.7 | 3.7 |

As shown in Table 5, the example prints of any given color generally exhibited better washfastness than the control prints or the comparative prints of the same color. Overall, the washfastness of the example prints (E-T) was generally improved relative to the washfastness of control prints A-D and the comparative prints U-X (when comparing the same color print). On average, higher loadings of the fixer composition led to slightly better washfastness results than lower loadings of the fixer composition.

Table 5 also shows that the comparative fixer did not improve the washfastness of the prints (comp. prints U-X) generated on either textile fabric when compared with the control prints (A-D) that had to fixer composition.

It is to be understood that the ranges provided herein include the stated range and any value or sub-range within the stated range, as if the value(s) or sub-range(s) within the stated range were explicitly recited. For example, a range from about 1 wt % active to about 10 wt % active, should be interpreted to include not only the explicitly recited limits of from about 1 wt % active to about 10 wt % active, but also to include individual values, such as about 1.15 wt % active, about 2.5 wt % active, 4.0 wt % active, 6.77 wt % active, 8.85 wt % active, 9.33 wt % active, etc., and sub-ranges, such as from about 2 wt % active to about 5.65 wt % active, from about 3 wt % active to about 7 wt % active, from about 4.35 wt % active to about 8.95 wt % active, etc. Furthermore, when “about” is utilized to describe a value, this is meant to encompass minor variations (up to +/−12%) from the stated value.

Reference throughout the specification to “one example”, “another example”, “an example”, and so forth, means that a particular element (e.g., feature, structure, and/or characteristic) described in connection with the example is included in at least one example described herein, and may or may not be present in other examples. In addition, it is to be understood that the described elements for any example may be combined in any suitable manner in the various examples unless the context clearly dictates otherwise.

In describing and claiming the examples disclosed herein, the singular forms “a”, “an”, and “the” include plural referents unless the context clearly dictates otherwise.

While several examples have been described in detail, it is to be understood that the disclosed examples may be modified. Therefore, the foregoing description is to be considered non-limiting.

What is claimed is:

1. A fixer composition, comprising:
a glycidyl amine resin including at least two epoxide groups, a phenyl group, and a tertiary amine group;
an acid;
a co-solvent; and
a balance of water.

2. The fixer composition as defined in claim 1 wherein the glycidyl amine resin is selected from the group consisting of tetraglycidyl meta-xylenediamine, N,N′-tetraglycidyl diaminodiphenylmethane, triglycidylether meta-aminophenol, triglycidylether para-aminophenol, and combinations thereof.

3. The fixer composition as defined in claim 1 wherein the acid is selected from the group consisting of CH₃COOH (acetic acid), HCO₂H (formic acid), alkyl-CO₂H, HCl (hydrochloric acid), HNO₃ (nitric acid), H₂SO₄ (sulfuric acid), and alkyl-SO₃H.

4. The fixer composition as defined in claim 1, further comprising a non-ionic surfactant, a cationic surfactant, a zwitterionic surfactant, or combinations thereof.

5. The fixer composition as defined in claim 1 wherein a molar ratio of the tertiary amine group of the glycidyl amine resin to the acid ranges from 1:0.5 to about 1:2.

6. The fixer composition as defined in claim 1 wherein the co-solvent is selected from the group consisting of propylene glycol monomethyl ether, propylene glycol propyl ether, dipropylene glycol n-butyl ether, propylene glycol phenyl ether, tripropylene glycol n-butyl ether, ethylene glycol butyl ether, dipropylene glycol methyl ether, diacetone alcohol, 2-pyrrolidone, N-methyl-2-pyrrolidone, N-ethyl-2-pyrrolidone 2-piperidinone, and combinations thereof.

7. The fixer composition as defined in claim 1 wherein the glycidyl amine resin is present in an amount ranging from about 0.5 wt % active to about 12 wt % active, based on a total weight of the fixer composition.

8. The fixer composition as defined in claim 1 wherein the fixer composition has a pH of about 8.5 or less.

9. The fixer composition as defined in claim 1 wherein the co-solvent is present in an amount ranging from about 1 wt % to about 20 wt %, based on a total weight of the fixer composition.

10. A printing kit, comprising:
a fixer composition, including:
a glycidyl amine resin including at least two epoxide groups, a phenyl group, and a tertiary amine group;
an acid;
a co-solvent; and
a balance of water; and
an ink composition, including:
a pigment;
a polymeric binder; and
an aqueous ink vehicle.

11. The printing kit as defined in claim 10, further comprising a textile fabric selected from the group consisting of polyester fabrics, polyester blend fabrics, cotton fabrics, cotton blend fabrics, nylon fabrics, nylon blend fabrics, silk fabrics, silk blend fabrics, wool fabrics, wool blend fabrics, and combinations thereof.

12. The printing kit as defined in claim 10 wherein:
the fixer composition has a pH of about 8.5 or less; and
the ink composition has a pH of greater than 7.

13. The printing kit as defined in claim 10 wherein:
the glycidyl amine resin is selected from the group consisting of tetraglycidyl meta-Xylenediamine, N,N′-tetraglycidyl diaminodiphenylmethane, triglycidylether meta-aminophenol, triglycidylether para-aminophenol, and combinations thereof; and
the acid is selected from the group consisting of CH₃COOH (acetic acid), HCO₂H (formic acid), alkyl-CO₂H, HCl (hydrochloric acid), HNO₃ (nitric acid), H₂SO₄ (sulfuric acid), and alkyl-SO₃H.

14. The printing kit as defined in claim 13 wherein a molar ratio of the tertiary amine group of the glycidyl amine resin to the acid ranges from 1:0.5 to about 1:2.

15. A method, comprising:
ejecting a fixer composition onto a textile fabric, the fixer composition including:
a glycidyl amine resin including at least two epoxide groups, a phenyl group, and a tertiary amine group;
an acid;
a co-solvent; and
a balance of water; and
ejecting an ink composition on the fixer composition on the textile fabric, the ink composition, including:
a pigment;
a polymeric binder; and
an aqueous ink vehicle; and
thermally curing the fixer and ink compositions.
